(19) United States
(12) Patent Application Publication
(10) Pub. No.: US 2020/0193333 A1
(43) Pub. Date: Jun. 18, 2020

(54) EFFICIENT REINFORCEMENT LEARNING BASED ON MERGING OF TRAINED LEARNERS

(71) Applicant: FUJITSU LIMITED, Kawasaki-shi (JP)

(72) Inventor: Hidenao Iwane, Kawasaki (JP)

(73) Assignee: FUJITSU LIMITED, Kawasaki-shi (JP)

(21) Appl. No.: 16/709,144

(22) Filed: Dec. 10, 2019

(30) Foreign Application Priority Data
Dec. 14, 2018 (JP) 2018-234405

(51) Int. Cl. G06N 20/20

(52) U.S. Cl. CPC G06N 20/20

(57) ABSTRACT

First reinforcement learning is performed, based on an action of a basic controller defining an action on a state of an environment, to obtain a first reinforcement learner by using a state-action value function expressed in a polynomial in an action range smaller than an action-range limit for the environment. Second reinforcement learning is performed, based on an action of a first controller including the first reinforcement learner, to obtain a second reinforcement learner by using a state-action value function expressed in a polynomial in an action range smaller than the action-range limit. Third reinforcement learning is performed, based on an action of a second controller including a merged reinforcement learner obtained by merging the first reinforcement learner and the second reinforcement learner, to obtain a third reinforcement leaner by using a state-action value function expressed in a polynomial in an action range smaller than the action-range limit.

### CROSS-REFERENCE TO RELATED APPLICATION

This application is based upon and claims the benefit of priority of the prior Japanese Patent Application No. 2018-234405, filed on Dec. 14, 2018, the entire contents of which are incorporated herein by reference,

### FIELD

The embodiment discussed herein is related to efficient reinforcement learning based on merging of trained learners.

### BACKGROUND

In the related art, in reinforcement learning, a process of updating a controller for performing a search action on an environment, observing a reward that corresponds to the search action, and deciding a greedy action, which is determined to be optimum as an action on the environment, based on the observation result, is repeatedly performed, and the environment is controlled. The search action is, for example, a random action or a greedy action determined to be optimum in the present situation.

As a related art, for example, there is a technology that optimizes a control parameter in a control module for normal control that determines an output related to an operation amount of a control target based on predetermined input information. For example, there is a technology for storing a time-series signal output corresponding to an unstored input signal for a predetermined period or time, analyzing the stored signal, and determining an output that corresponds to an unstored input signal. For example, there is a technology for generating a problem about a quantifier elimination method on a real closed body from a cost function that represents a relationship between a parameter set and a cost, and performing a process regarding the quantifier elimination method by term replacement.

Japanese Laid-open Patent. Publication Nos. 2000-250603, 6-44205, and 2013-47869 are examples of related art.

### SUMMARY

According to an aspect of the embodiments, first reinforcement learning is performed, based on an action obtained by a basic controller that defines an action on a state of an environment, to obtain a first reinforcement learner by using a state action value function expressed in a polynomial in an action range smaller than an action range limit for the environment. Second reinforcement learning is performed, based on an action obtained by a first controller that includes the first reinforcement learner, to obtain a second reinforcement learner by using a state action value function expressed in a polynomial in an action range smaller than the action range limit. Third reinforcement learning is performed, based on an action obtained by a second controller that includes a merged reinforcement learner obtained by merging the first reinforcement learner and the second reinforcement learner, to obtain a third reinforcement leaner by using a state action value function expressed in a polynomial in an action range smaller than the action range limit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a reinforcement learning method according to an embodiment;

FIG. 2 is a block diagram illustrating a hardware configuration example of an information processing apparatus;

FIG. 3 is an explanatory diagram illustrating an example of stored contents of a history table;

FIG. 4 is a block diagram illustrating a functional configuration example of the information processing apparatus;

FIG. 5 is an explanatory diagram illustrating a flow of operations for repeating reinforcement learning;

FIG. 6 is an explanatory diagram illustrating a change in an action range for determining a search action;

FIG. 7 is an explanatory diagram illustrating details of a j-th reinforcement learning in a case where mⱼ=M and there is no action constraint;

FIG. 8 is an explanatory diagram illustrating details of the j-th reinforcement learning in a case where mⱼ<M and there is no action constraint;

FIG. 9 is an explanatory diagram illustrating details of the j-th reinforcement learning in a case where mⱼ<M and there is an action constraint;

FIG. 10 is an explanatory diagram illustrating details of the j-th reinforcement learning in a case where actions are collectively corrected;

FIG. 11 is an explanatory diagram illustrating a specific example of merging;

FIG. 12 is an explanatory diagram illustrating a specific example of merging including a basic controller;

FIG. 13 is an explanatory diagram illustrating a specific control example of environment;

FIG. 14 is an explanatory diagram (part 1) illustrating a result of repeating the reinforcement learning;

FIG. 15 is an explanatory diagram (part 2) illustrating a result of repeating the reinforcement learning;

FIG. 16 is an explanatory diagram illustrating a change in processing amount for each reinforcement learning;

FIG. 17 is an explanatory diagram (part 1) illustrating a specific example of the environment;

FIG. 18 is an explanatory diagram (part 2) illustrating a specific example of the environment;

FIG. 19 is an explanatory diagram (part 3) illustrating a specific example of the environment;

FIG. 20 is a flowchart illustrating an example of a reinforcement learning processing procedure;

FIG. 21 is a flowchart illustrating an example of an action determining processing procedure;

FIG. 22 is a flowchart illustrating another example of the action determining processing procedure;

FIG. 23 is a flowchart illustrating an example of a merge processing procedure; and

FIG. 24 is a flowchart illustrating another example of the merge processing procedure.

### DESCRIPTION OF EMBODIMENTS

In the related art, in a case where the search action on the environment is a random action, there is a case where an inappropriate action that adversely affects the environment is performed. In contrast, it is considered to avoid an inappropriate action by repeating the process of learning a reinforcement learner that defines a correction amount for determining the greedy action more appropriately, in an action range based on the current greedy action. However, each time the process is repeated, the number of reinforcement learners used when determining the greedy action increases, and a processing amount required when determining the greedy action increases.

In one aspect, it is desirable to reduce a processing amount required when searching for an optimum action while avoiding an inappropriate action.

Hereinafter, with reference to the drawings, an embodiment of a reinforcement learning method and a reinforcement learning program according to the present embodiment will be described in detail,

(One Example of Reinforcement Learning Method according to Embodiment)

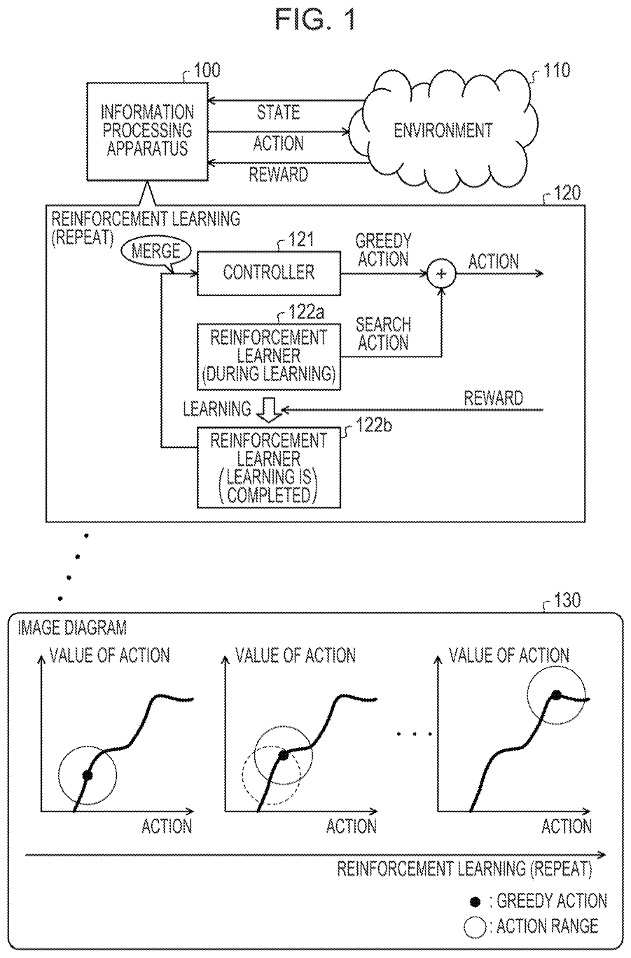

FIG. 1 is an explanatory diagram illustrating an example of the reinforcement learning method according to the embodiment. An information processing apparatus 100 is a computer that controls an environment 110 by determining an action on the environment 110 by using the reinforcement learning. The information processing apparatus 100 is, for example, a server, a personal computer (PC), or the like.

The environment 110 is any event that is a control target, for example, a physical system that actually exists. Specifically, the environment 110 is an automobile, an autonomous mobile robot, a drone, a helicopter, a server room, a generator, a chemical plant, a game, or the like. The action is an operation with respect to the environment 110. The action is also called input. The action is a continuous quantity. A state of the environment 110 changes corresponding to the action on the environment 110. The state of the environment 110 is observable.

In the related art, in reinforcement learning, a process of updating a controller for performing a search action on the environment 110, observing a reward that corresponds to the search action, and determining a greedy action determined to be optimum as an action on the environment 110 based on the observation result, is repeatedly performed, and the environment 110 is controlled. The search action is a random action or a greedy action determined to be optimum in the present situation.

The controller is a control rule for determining the greedy action. The greedy action is an action determined to be optimum in the present situation as an action on the environment 110. The greedy action is, for example, an action determined to maximize a discount accumulated reward or an average reward in the environment 110. The greedy action does not necessarily coincide with the optimum action that is truly optimum. There is a case where the optimum action is not known by humans.

Here, in a case where the search action on the environment 110 is a random action, there is a case where an inappropriate action that adversely affects the environment 110 is performed.

For example, a case where the environment 110 is a server room and the action on the environment 110 is a set temperature of air conditioning equipment in the server room, is considered. In this case, there is a case where the set temperature of the air conditioning equipment is randomly changed and is set to a high temperature that causes a server in the server room to break down or malfunction. Meanwhile, there is a case where the set temperature of the air conditioning equipment is set to a low temperature such that power consumption significantly increases.

For example, a case where the environment 110 is an unmanned air vehicle and the action on the environment 110 is a set value for a driving system of the unmanned air vehicle, is considered. In this case, there is a case where the set value of the driving system is randomly changed and is set to a set value that makes a stable fly difficult, and the unmanned air vehicle falls.

For example, a case where the environment 110 is a windmill and the action on the environment 110 is a load torque of the generator coupled to the windmill, is considered. In this case, there is a case where the load torque is randomly changed and is a load torque that significantly reduces the power generation amount.

Therefore, when controlling the environment 110 by using the reinforcement learning, it is preferable to update the controller for determining the greedy action while avoiding an inappropriate action.

In contrast, a method for repeating a process of performing the reinforcement learning in an action range based on the greedy action obtained by the current controller, learning the reinforcement learner, and generating a new controller obtained by combining the current controller and the learned reinforcement learner with each other, is considered. The reinforcement learner defines a correction amount of the action for more appropriately determining the greedy action. According to this method, it is possible to update the controller while avoiding an inappropriate action.

However, in this method, each time the process is repeated, the number of reinforcement learners included in the controller and used when determining the greedy action increases, and thus, there is a problem that the processing amount required when determining the greedy action increases.

Here, in the embodiment, a reinforcement learning method in which, each time the reinforcement learning is performed in the action range based on the greedy action obtained by the current controller, the reinforcement learner learned by the reinforcement learning is merged with the reinforcement learner included in the current controller, will be described. The reinforcement learning here is a series of processes from learning one reinforcement learner by trying the action a plurality of times until generating a new controller.

In FIG. 1, the information processing apparatus 100 repeatedly performs reinforcement learning 120. The reinforcement learning 120 is a series of processes of determining the action on the environment 110 by a latest controller 121 and a reinforcement learner 122a which is in the middle of learning, learning the reinforcement learner 122b from the reward that corresponds to the action, and generating a new controller by combining the learned reinforcement learner 122b with the controller 121. The controller 121 is a control rule for determining the greedy action determined to be currently optimum, with respect to the state of the environment 110.

The reinforcement learner 122a is newly generated, used, and learned for each reinforcement learning 120. The reinforcement learner 122b is a control rule for determining the action that is a correction amount for the greedy action obtained by the controller 121 by using a state action value function within the action range based on the greedy action obtained by the controller 121.

The state action value function is a function for calculating a value that indicates the value of the action obtained by the reinforcement learner 122a, with respect to the state of the environment 110. In order to maximize the discount accumulated reward or the average reward in the environment 110, as the discount accumulated reward or the average reward in the environment 110 increases, the value of the action is set to increase. The state action value function is expressed using a polynomial. As the polynomial, variables that represent the states and actions are used.

The reinforcement learner 122a is used for searching how to correct the greedy action obtained by the controller 121 during the learning, and determines the search action that is a correction amount for the greedy action obtained by the controller 121. The search action is a random action or a greedy action that maximizes the value of the state action value function. In determination of the search action, for example, a c greedy method or Boltzmann selection is used. Since the state action value function is expressed in a polynomial, for example, the greedy action is obtained by using a quantifier elimination on a real closed body. In the following description, there is a case where the quantifier elimination on a real closed body is simply expressed as “quantifier elimination”.

The quantifier elimination is to convert a first-order predicate logical expression described by using a quantifier into an equivalent logical expression that does not use a quantifier. The quantifier is a universal quantifier (∀) and an existential quantifier (∃). The universal quantifier (∀) is a symbol that targets a variable and modifies such that a logical expression is established even when the variables are all real values. The existential quantifier (∃) is a symbol that targets a variable and modifies such that one or more real values of the variables by which the logical expression is established exist.

The reinforcement learner 122a is learned by the reinforcement learning 120 to determine the greedy action that is a correction amount for correcting the greedy action obtained by the controller 121 to a more appropriate action based on the reward that corresponds to the search action. Specifically, a coefficient that expresses the state action value function used in the reinforcement learner 122a is learned so as to determine the greedy action that is a correction amount for correcting the greedy action obtained by the controller 121 to a more appropriate action by the reinforcement learning 120. In the learning of the coefficient, for example, Q learning or SARSA is used. The reinforcement learner 122a is fixed as the reinforce learner 122b so as to determine the greedy action whenever the learning is completed.

Here, in a case where there is the reinforcement learner included in the controller 121, the information processing apparatus 100 merges the learned reinforcement learner 122b with the reinforcement learner included in the controller 121, generates a new reinforcement learner, and accordingly combines the learned reinforcement learner 122b with the controller 121. Merging is realized by using the quantifier elimination, for example, because the state action value function is expressed in a polynomial.

According to this, as illustrated in an image diagram 130, the information processing apparatus 100 is capable of determining the search action by the reinforcement learner 122b within the action range based on the greedy action obtained by the latest controller 121 when the reinforcement learning 120 is performed. Therefore, the information processing apparatus 100 is capable of stopping the action that is more than a certain distance away from the greedy action obtained by the latest controller 121 and avoiding an inappropriate action that adversely affects the environment 110.

As illustrated in the image diagram 130, each time the reinforcement learning 120 is repeated, the information processing apparatus 100 is capable of generating a new controller that is capable of determining the greedy action with higher value than that of the latest controller 121. The information processing apparatus 100 is capable of determining the greedy action that maximizes the value of the action such that the discount accumulated reward or the average reward increases as a result of repeating the reinforcement learning 120, and generating a controller that is capable of appropriately controlling the environment 110.

The information processing apparatus 100 is capable of merging the learned reinforcement learner 122b with the reinforcement learner included in the controller 121 each time the reinforcement learning 120 is performed. Therefore, even when the reinforcement learning 120 is repeated, the information processing apparatus 100 is capable of maintaining the number of reinforcement learners included in the controller 121 below a certain level. As a result, when determining the greedy action by the controller 121, the information processing apparatus 100 is capable of suppressing the number of reinforcement learners to be calculated below a certain level, and an increase in the processing amount required when the controller 121 determines the greedy action.

Next, specific contents of the above-described reinforcement learning 120 will be described. Specifically, the information processing apparatus 100 sequentially performs first reinforcement learning, second reinforcement learning, and third reinforcement learning, for example, as illustrated in (1-1) to (1-3) below. The first reinforcement learning corresponds to the reinforcement learning 120 that is performed firstly, the second reinforcement learning corresponds to the reinforcement learning 120 that is performed secondly, and the third reinforcement learning is the reinforcement learning 120 that is performed thirdly.

(1-1) The information processing apparatus 100 uses a basic controller as the latest controller. The basic controller is a control rule for determining the greedy action on the state of the environment 110. The basic controller is set by a user, for example. The information processing apparatus 100 performs the first reinforcement learning in the action range smaller than an action range limit for the environment 110 based on the greedy action obtained by the basic controller. The action range limit indicates how far away from the greedy action obtained by the basic controller the action is allowed, and is a condition to stop a case where an inappropriate action that is more than a certain distance away from the greedy action obtained by the basic controller is performed. The action range limit is set by the user, for example.

The first reinforcement learning is a series of processes of generating a first reinforcement learner, trying the action a plurality of times by using the first reinforcement learner, and newly generating a first controller that is capable of determining the greedy action determined to be more appropriate than that of the basic controller. In the first reinforcement learning, the first reinforcement learner is learned and combined with the basic controller, and the first controller is newly generated.

The first reinforcement learner is a control rule for determining an action that is a correction amount for the greedy action obtained by the basic controller, by using the state action value function within the action range based on the greedy action obtained by the basic controller. The first reinforcement learner is used for searching how to correct the greedy action obtained by the basic controller during the learning, and determines the search action that is a correction amount for the greedy action obtained by the basic controller in various manners. The first reinforcement learner determines the greedy action that maximizes the value of the state action value function whenever the learning is completed and fixed.

The information processing apparatus 100 determines the search action that is the correction amount of the action in the action range smaller than the action range limit based on the greedy action determined to be optimum by the basic controller, by using the first reinforcement learner at regular intervals. The information processing apparatus 100 corrects the greedy action determined to be optimum by the basic controller with the search action determined by the first reinforcement learner, determines the action on the environment 119 and performs the determined action. The information processing apparatus 100 observes the reward that corresponds to the search action. The information processing apparatus 100 learns the first reinforcement learner based on the observation result, completes and fixes the learning of the first reinforcement learner, combines the basic controller and the fixed first reinforcement learner with each other, and newly generates the first controller. The first controller includes the basic controller and the fixed first reinforcement learner.

(1-2) The information processing apparatus 100 performs the second reinforcement learning in the action range smaller than the action range limit based on the greedy action obtained by the first controller. The second reinforcement learning is a series of processes of generating a second reinforcement learner, performing the learning by trying the action a plurality of times by using the second reinforcement learner, and newly generating a second controller that is capable of determining the greedy action determined to be more appropriate than that of the first controller. In the second reinforcement learning, the second reinforcement learner is learned and combined with the first controller, and the second controller is newly generated,

The second reinforcement learner is a control rule for determining an action that is a correction amount for the greedy action obtained by the first controller, by using the state action value function within the action range based on the greedy action obtained by the first controller. The second reinforcement learner is used for searching how to correct the greedy action obtained by the first controller during the learning, and determines the search action that is a correction amount for the greedy action obtained by the first controller in various manners. The second reinforcement learner determines the greedy action that maximizes the value of the state action value function of the second reinforcement learner whenever the learning is completed and fixed.

The information processing apparatus 100 determines the search action that is the correction amount of the action in the action range smaller than the action range limit based on the greedy action determined to be optimum by the first controller, by using the second reinforcement learner at regular intervals. The information processing apparatus 100 corrects the greedy action determined to be optimum by the first controller with the determined search action, determines the action on the environment 110, and performs the determined action. The information processing apparatus 100 observes the reward that corresponds to the search action. The information processing apparatus 100 learns the second reinforcement learner based on the observation result, and fixes the second reinforcement learner as the learning is completed. The information processing apparatus 100 newly generates the second controller by merging the learned second reinforcement learner with the first reinforcement learner included in the first controller. The second controller includes the basic controller and a new reinforcement learner obtained by merging the first reinforcement learner and the second reinforcement learner with each other.

(1-3) The information processing apparatus 100 performs the third reinforcement learning in the action range smaller than the action range limit based on the greedy action obtained by the second controller. The third reinforcement learning is a series of processes of generating a third reinforcement learner, trying the action a plurality of times by using the third reinforcement learner, and newly generating a third controller that is capable of determining the greedy action determined to be more appropriate than that of the second controller. In the third reinforcement learning, the third reinforcement learner is learned and combined with the second controller, and the third controller is newly generated,

The third reinforcement learner is a control rule for determining an action that is a correction amount for the greedy action obtained by the second controller, by using the state action value function within the action range based on the greedy action obtained by the second controller. The third reinforcement learner is used for searching how to correct the greedy action obtained by the second controller during the learning, and determines the search action that is a correction amount for the greedy action obtained by the second controller in various manners. The third reinforcement learner determines the greedy action that maximizes the value of the state action value function of the third reinforcement learner whenever the learning is completed and fixed.

The information processing apparatus 100 determines the search action that is the correction amount of the action in the action range smaller than the action range limit based on the greedy action determined to be optimum by the second controller, by using the third reinforcement learner at regular intervals. The information processing apparatus 100 corrects the greedy action determined to be optimum by the second controller with the determined search action, determines the action on the environment 110, and performs the determined action. The information processing apparatus 100 observes the reward that corresponds to the search action. The information processing apparatus 100 learns the third reinforcement learner based on the observation result, and fixes the third reinforcement learner as the learning is completed. The information processing apparatus 100 newly generates the third controller by further merging the learned third reinforcement learner with the reinforcement learner obtained by merging the first reinforcement learner included in the second controller and the second reinforcement learner with each other. The third controller includes a new reinforcement learner obtained by merging the basic controller and the first reinforcement learner, the second reinforcement learner, and the third reinforcement learner with each other.

Accordingly, the information processing apparatus 100 is capable of determining the search action by the reinforcement learner within the action range based on the greedy action determined to be optimum by the latest controller when performing the reinforcement learning. Therefore, the information processing apparatus 100 is capable of stopping the action that is more than a certain distance away from the greedy action determined to be optimum by the latest controller and avoiding an inappropriate action that adversely affects the environment 110.

Each time the information processing apparatus 100 repeats the reinforcement learning, the information processing apparatus 100 is capable of generating a new controller that is capable of determining the greedy action determined to be more appropriate than the latest controller while avoiding an inappropriate action. As a result, the information processing apparatus 100 is capable of determining the greedy action that maximizes the value of the action such that the discount accumulated reward or the average reward increases, and generating an appropriate controller that is capable of appropriately controlling the environment 110.

The information processing apparatus 100 is capable of merging the learned reinforcement learner with the reinforcement learner included in the latest controller each time the reinforcement learning is performed. Therefore, even when the reinforcement learning is repeated, the information processing apparatus 100 is capable of maintaining the number of reinforcement learners included in the latest controller below a certain level. As a result, when determining the greedy action by the latest controller, the information processing apparatus 100 is capable of suppressing the number of reinforcement learners to be calculated below a certain level, and an increase in the processing amount required when the latest controller determines the greedy action.

For example, in a case where the first reinforcement learner and the second reinforcement learner are not merged with each other, when the third reinforcement learning is performed, the first reinforcement learner and the second reinforcement learner are processed separately, and as a result, the processing amount required when determining the greedy action increases. In contrast, when the third reinforcement learning is performed, the information processing apparatus 100 is capable of determining the greedy action when processing one reinforcement learner included in the second controller and obtained by merging the first reinforcement learner and the second reinforcement learner with each other. Therefore, the information processing apparatus 100 is capable of reducing the processing amount required when determining the greedy action by the second controller.

A case where the information processing apparatus 180 performs the third reinforcement learning one time has been described here, but the embodiment is not limited thereto. For example, there may be a case where the information processing apparatus 100 repeatedly performs the third reinforcement learning in the action range smaller than the action range limit based on the greedy action obtained by the third controller generated by the third reinforcement learning performed immediately before. In this case, each time the third reinforcement learning is performed, the information processing apparatus 100 merges the third reinforcement learner learned by the third reinforcement learning performed this time with the reinforcement learner included in the third controller generated by the third reinforcement learning performed immediately before, and generates the new third controller.

Accordingly, the information processing apparatus 100 is capable of determining the search action by the reinforcement learner within the action range based on the greedy action determined to be optimum by the latest controller when performing the reinforcement learning. Therefore, the information processing apparatus 100 is capable of stopping the action that is more than a certain distance away from the greedy action determined to be optimum by the latest controller and avoiding an inappropriate action that adversely affects the environment 110,

Each time the information processing apparatus 100 repeats the reinforcement learning, the information processing apparatus 100 is capable of generating a new controller that is capable of determining the greedy action determined to be more appropriate than the latest controller while avoiding an inappropriate action. As a result, the information processing apparatus 100 is capable of determining the greedy action that maximizes the value of the action such that the discount accumulated reward or the average reward increases, and generating an appropriate controller that is capable of appropriately controlling the environment 110.

The information processing apparatus 100 is capable of merging the learned reinforcement learner with the reinforcement learner included in the latest controller each time the reinforcement learning is performed. Therefore, even when the reinforcement learning is repeated, the information processing apparatus 100 is capable of maintaining the number of reinforcement learners included in the latest controller below a certain level. As a result, when determining the greedy action by the latest controller, the information processing apparatus 100 is capable of suppressing the number of reinforcement learners to be calculated below a certain level, and an increase in the processing amount required when the latest controller determines the greedy action.

For example, in a case where the reinforcement learners learned in the past are not merged with each other, when performing any third reinforcement learning, all of the reinforcement learners learned in the past are processed separately, and thus, an increase in the processing amount required when determining the greedy action is caused. In contrast, when any third reinforcement learning is performed, the information processing apparatus 100 is capable of determining the greedy action when processing one reinforcement learner obtained by merging all of the reinforcement learners learned in the past with each other. Therefore, the information processing apparatus 100 is capable of reducing the processing amount required when determining the greedy action.

Here, a case where the information processing apparatus 100 uses the action range limit of which the size is fixed each time the reinforcement learning is performed has been described, but the embodiment is not limited thereto. For example, there may be a case where the information processing apparatus 100 uses an action range limit of which the size is variable each time the reinforcement learning is performed.

(Hardware Configuration Example of information Processing Apparatus 100)

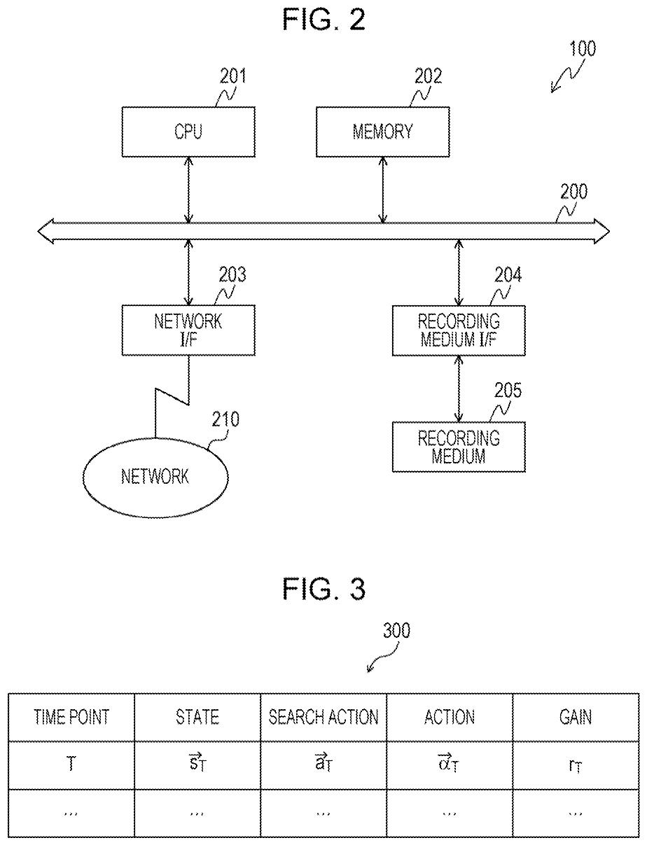

Next, a hardware configuration example of the information processing apparatus 100 will be described with reference to FIG. 2.

FIG. 2 is a block diagram illustrating the hardware configuration example of the information processing apparatus 100. In FIG. 2, the information processing apparatus 100 includes a central processing unit (CPU) 201, a memory 202, a network interface (I/F) 203, a recording medium I/F 204, and a recording medium 205. Each of the components is coupled to each other via a bus 200.

Here, the CPU 201 controls the entirety of the information processing apparatus 100. The memory 202 includes, for example, a read-only memory (ROM), a random-access memory (RAM), a flash ROM, and the like. For example, the flash ROM or the ROM stores various programs, and the RAM is used as a work area of the CPU 201. The program stored in the memory 202 causes the CPU 201 to execute coded processing by being loaded into the CPU 201. The memory 202 may store a history table 300 which will be described later in FIG. 3.

The network I/F 203 is coupled to the network 210 through a communication line and is coupled to another computer via the network 210. The network I/F 203 controls the network 210 and an internal interface so as to control data input/output from/to the other computer As the network I/F 203, for example, it is possible to adopt a modem, a local area network (LAN) adapter, or the like.

The recording medium I/F 204 controls reading/writing of data from/to the recording medium 205 under the control of the CPU 201. The recording medium I/F 204 is, for example, a disk drive, a solid state drive (SSD), a Universal Serial Bus (USB) port, or the like. The recording medium 205 is a nonvolatile memory that stores the data written under the control of the recording medium I/F 204. The recording medium 205 is, for example, a disk, a semiconductor memory, a USB memory, or the like. The recording medium 205 may be detachable from the information processing apparatus 100. The recording medium 205 may store the history table 300 which will be described later in FIG. 3.

In addition to the above-described components, the information processing apparatus 100 may include, for example, a keyboard, a mouse, a display, a printer, a scanner, a microphone, a speaker, and the like. The information processing apparatus 100 may include a plurality of the recording media I/F 204 or a plurality of the recording media 205. The information processing apparatus 100 may not include the recording medium I/F 204 or the recording medium 205.

(Stored Contents of History Table 300)

Next, the stored contents of a history table 300 will be described with reference to FIG. 3. The history table 300 is realized by using, for example, a storage region, such as the memory 202 or the recording medium 205, in the information processing apparatus 100 illustrated in FIG. 2.

FIG. 3 is an explanatory diagram illustrating an example of the stored contents of the history table 300. As illustrated in FIG. 3, the history table 300 includes fields of the state, the search action, the action, and the reward in association with a time point field. The history table 300 stores history information by setting information in each field for each time point.

In the time point field, time points at predetermined time intervals are set. In the state field, the states of the environment 110 at the time points are set. In the search action field, the search actions on the environment 110 at the time points are set. In the action field, the actions on the environment 110 at the time points are set. In the reward field, the rewards that correspond to the actions on the environment 110 at the time points are set.

(Functional Configuration Example of Information Processing Apparatus 100)

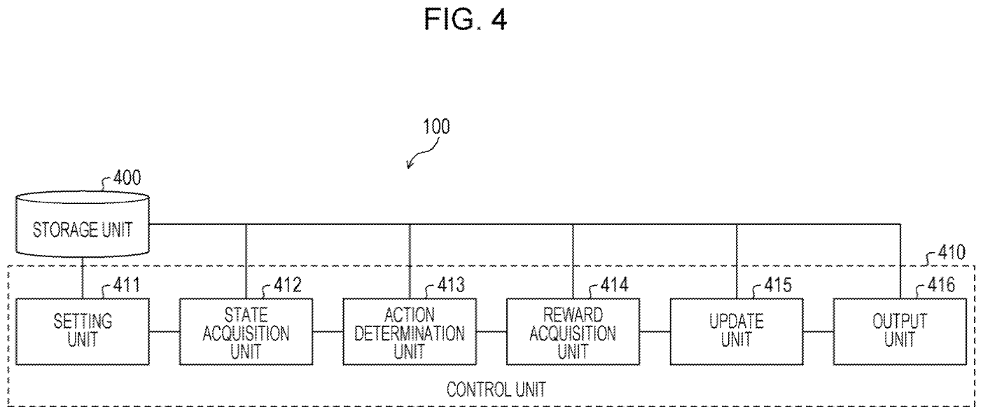

Next, a functional configuration example of the information processing apparatus 100 will be described with reference to FIG. 4.

FIG. 4 is a block diagram illustrating the functional configuration example of the information processing apparatus 100. The information processing apparatus 100 includes a storage unit 400, a setting unit 411, a state acquisition unit 412, an action determination unit 413, a reward acquisition unit 414, an update unit 415, and an output unit 416.

The storage unit 400 is realized by using, for example, a storage region, such as the memory 202 or the recording medium 205 illustrated in FIG. 2. Hereinafter, a case where the storage unit 400 is included in the information processing apparatus 100 will be described, but the embodiment is not limited thereto. For example, there may be a case where the storage unit 400 is included in an apparatus different from the information processing apparatus 100 and the information processing apparatus 100 is capable of referring to the stored contents of the storage unit 400.

The units from the setting unit 411 to the output unit 416 function as an example of a control unit 410. Specifically, the functions of the units from the setting unit 411 to the output unit 416 are realized by, for example, causing the CPU 201 to execute a program stored in the storage region, such as the memory 202 or the recording medium 205 illustrated in FIG. 2, or by using the network I/F 203. Results of processing performed by each functional unit are stored in the storage region, such as the memory 202 or the recording medium 205 illustrated in FIG. 2.

The storage unit 400 stores a variety of pieces of information to be referred to or updated in the processing of each functional unit. The storage unit 400 stores an action on the environment 110, a search action, a state of the environment 110, and a reward from the environment 110. The action is a real value that is a continuous quantity. The search action is an action that is a correction amount for the greedy action. The search action is an action including a random action or the greedy action that maximizes the value based on the state action value function. The search action is used for determining the action on the environment 110. For example, the storage unit 400 stores, for each time point, the action on the environment 110, the search action, the state of the environment 110, and the reward from the environment 110 by using the history table 300 illustrated in FIG. 3.

The storage unit 400 stores a basic controller. The basic controller is a control rule for determining the greedy action determined to be optimum in an initial state, with respect to the state of the environment 110. The basic controller is set by a user, for example. The basic controller is, for example, a PI controller or a fixed controller that outputs a certain action. The storage unit 400 stores a newly generated controller. The controller is a control rule for determining the greedy action determined to be optimum in the present situation, with respect to the state of the environment 110. The storage unit 400 stores the action range limit for the environment 110. The action range limit indicates how far away from the greedy action obtained by the controller the action is allowed, and is a condition to stop a case where an inappropriate action that is more than a certain distance away from the greedy action is performed. The action range limit is set by the user, for example. The storage unit 400 stores a reinforcement learner that is newly generated and used for the reinforcement learning. The reinforcement learner is a control rule for determining the action that is a correction amount for the greedy action obtained by the controller by using a state action value function within the action range smaller than the action range limit based on the greedy action obtained by the controller.

The storage unit 400 stores the state action value function used for the reinforcement learner. The state action value function is a function for calculating a value that indicates the value of the action obtained by the reinforcement learner, with respect to the state of the environment 110. In order to maximize the discount accumulated reward or the average reward in the environment 110, as the discount accumulated reward or the average reward in the environment 110 increases, the value of the action is set to increase. Specifically, the value of the action is a Q value that indicates how much the action on the environment 110 contributes to the reward. The state action value function is expressed using a polynomial. As the polynomial, variables that represent the states and actions are used. The storage unit 400 stores, for example, a polynomial that expresses the state action value function and a coefficient that is applied to the polynomial. Accordingly, the storage unit 400 is capable of making each processing unit refer to various types of information.

(Description of Various Processes by Entire Control Unit 410)

In the following description, various processes performed by the entire control unit 410 will be described, and then various processes performed by each functional unit from the setting unit 411 to the output unit 416 that function as an example of the control unit 410 will be described. First, various processes performed by the entire control unit 410 will be described.

In the following description, i is a symbol that represents the number of the reinforcement learning assigned for convenience of the description, and represents the number of the performed reinforcement learning. j≥i≥1 is satisfied. j is the number of the latest reinforcement learning. j is, for example, the number of reinforcement learning to be performed this time or the number of reinforcement learning which is being performed. j≥1 is satisfied.

RLᵢ is a symbol that represents the i-th reinforcement learner. RLᵢ is expressed with a superscript “fix” in a case of clearly indicating that the case is after the learning is completed and fixed by the i-th reinforcement learning. RL*ᵢ is a symbol that represents a reinforcement learner that corresponds to the result of merging RL₁ to RLᵢ with each other. It is possible to obtain RL*ᵢ by merging RL*_{I-1} and RLᵢ with each other when i≥2.

Cᵢ is a symbol that represents a controller generated by the i-th reinforcement learning. C₀ is a symbol that represents a basic controller. C*ᵢ is a symbol that represents a reinforcement learner that corresponds to the result of merging C₀ and RL₁ to RLᵢ with each other in a case where C₀ is expressed by a logical expression and it is possible merge C₀ with RL₁ to RLᵢ. It is possible to obtain C*ᵢ by merging C*ᵢ₋₁ and RLᵢ when i≥2.

The control unit 410 uses the basic controller as the latest controller. The control unit 410 generates the first reinforcement learner to be used in the first reinforcement learning. The control unit 410 performs the first reinforcement learning in the action range smaller than the action range limit based on the greedy action obtained by the basic controller by using the first reinforcement learner.

The control unit 410 determines the search action that is the correction amount of the action in the action range smaller than the action range limit based on the greedy action determined to be optimum by the basic controller by using the first reinforcement learner at regular intervals. The control unit 410 corrects the greedy action determined to be optimum by the basic controller with the determined search action, and performs the action on the environment 110. The control unit 410 observes the reward that corresponds to the search action. The control unit 410 learns the first reinforcement learner based on the observation result, fixes the first reinforcement learner as the learning is completed, combines the basic controller and the fixed first reinforcement learner with each other, and newly generates the first controller.

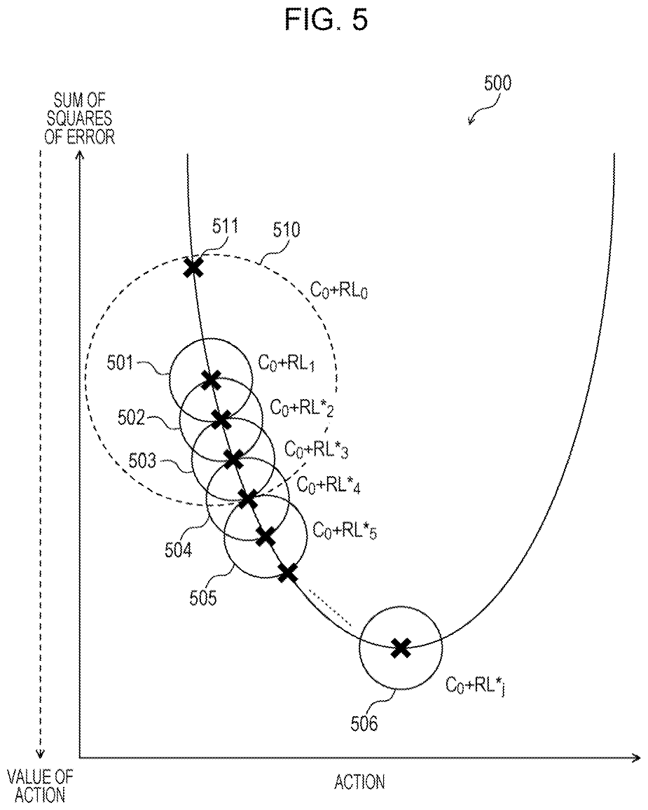

Specifically, the control unit 410 performs the first reinforcement learning which will be described later in FIG. 5. The control unit 410 determines the search action from the action range for the perturbation based on the greedy action obtained by the basic controller C₀ by using the first reinforcement learner RL₁ at regular intervals. Each time the control unit 410 determines the search action, the control unit 410 performs the action on the environment 110 based on the determined search action, and observes the reward that corresponds to the search action. The action range for the perturbation is smaller than the action range limit. In determination of the search action, for example, a ε greedy method or Boltzmann selection is used. The control unit 410 learns the first reinforcement learner RL₁ based on the reward for each search action observed as a result of performing the action a plurality of times, and fixes the first reinforcement learner RL₁ as the learning is completed. The learning of the reinforcement learner RL₁ uses, for example, Q learning or SARSA. The control unit 410 generates a first controller C₁=C₀+RL₁^{fix} including the basic controller C₀ and a fixed first reinforcement learner RL₁^{fix}.

Accordingly, in the first reinforcement learning, the control unit 410 is capable of performing the action that is not more than a certain distance away from the action obtained by the basic controller, and avoiding an inappropriate action. The control unit 410 is capable of generating the first controller that is capable of determining the appropriate greedy action and appropriately controlling the environment 110 rather than the basic controller while avoiding an inappropriate action.

The control unit 410 performs the second reinforcement learning in the action range smaller than the action range limit based on the greedy action obtained by the first controller. The control unit 410 determines the search action that is the correction amount of the action in the action range smaller than the action range limit based on the greedy action determined to be optimum by the first controller by using the second reinforcement learner at regular intervals. The control unit 410 corrects the greedy action determined to be optimum by the first controller with the determined search action, determines the action on the environment 110, and performs the determined action. The control unit 410 observes the reward that corresponds to the search action. The control unit 410 learns the second reinforcement learner based on the observation result, and fixes the second reinforcement learner as the learning is completed. The control unit 410 newly generates the second controller by merging the learned second reinforcement learner with the first reinforcement learner included in the first controller. The second controller includes the basic controller and a new reinforcement learner obtained by merging the first reinforcement learner and the second reinforcement learner with each other. Merging is performed using the quantifier elimination with respect to the first-order predicate logical expression using a polynomial.

Specifically, the control unit 410 performs the second reinforcement learning which will be described later in FIG. 5. The control unit 410 determines the search action from the action range for the perturbation based on the greedy action obtained by the first controller C₁=C₀+RL₁^{fix} generated immediately before by using the second reinforcement learner RL₂ at regular intervals. Each time the control unit 410 determines the search action, the control unit 410 performs the action on the environment 110 based on the determined search action, and observes the reward that corresponds to the search action. The control unit 410 learns the second reinforcement learner RL₂ based on the reward for each search action observed as a result of performing the action a plurality of times, and fixes the second reinforcement learner RL₂ as the learning is completed. The control unit 410 merges the fixed second reinforcement learner RL₂^{fix} with the first reinforcement learner RL₁^{fix} included in the first controller C₁=C₀+RL₁^{fix} generated immediately before. As a result, the control unit 410 generates the second controller C₂=C₀+RL*₂ including the reinforcement learner RL*₂ that corresponds to the result of merging the basic controller C₀ and the first reinforcement learner RL₁^{fix} and the second reinforcement learner RL₂^{fix} with each other.

Accordingly, in the second reinforcement learning, the control unit 410 is capable of performing the action that is not more than a certain distance away from the action obtained by the first controller, and avoiding an inappropriate action. The control unit 410 is capable of generating the second controller that is capable of determining the appropriate greedy action and appropriately controlling the environment 110 rather than the first controller generated by the first reinforcement learning while avoiding an inappropriate action. The control unit 410 is capable of reducing the number of reinforcement learners included in the second controller, and reducing the processing amount required when the greedy action is determined by the second controller.

The control unit 410 performs the third reinforcement learning in the action range smaller than the action range limit based on the greedy action obtained by the second controller. The control unit 410 determines the search action that is the correction amount of the action in the action range smaller than the action range limit based on the greedy action determined to be optimum by the second controller by using the third reinforcement learner at regular intervals. The control unit 410 corrects the greedy action determined to be optimum by the second controller with the determined search action, determines the action on the environment 110, and performs the determined action. The control unit 410 observes the reward that corresponds to the search action. The control unit 410 learns the third reinforcement learner based on the observation result, and fixes the third reinforcement learner as the learning is completed. The control unit 410 newly generates the third controller by further merging the learned third reinforcement learner with the reinforcement learner obtained by merging the first reinforcement learner included in the second controller and the second reinforcement learner with each other. The third controller includes a new reinforcement learner obtained by merging the basic controller and the first reinforcement learner, the second reinforcement learner, and the third reinforcement learner with each other.

Specifically, the control unit 410 performs the third reinforcement learning which will be described later in FIG. 5. The control unit 410 determines the search action from the action range for the perturbation based on the greedy action obtained by the second controller C₂=C₀+RL*₂ generated immediately before by using the third reinforcement learner RL₃ at regular intervals. Each time the control unit 410 determines the search action, the control unit 410 performs the action on the environment 110 based on the determined search action, and observes the reward that corresponds to the search action. The control unit 410 learns the third reinforcement learner RL₃ based on the reward for each search action observed as a result of performing the action a plurality of times, and fixes the third reinforcement learner RL₃ as the learning is completed. The control unit 410 further merges the fixed third reinforcement learner RL₃^{fix} with the merged reinforcement learner RL*₂ included in the second controller C₂=C₀+RL*₂ generated immediately before. As a result, the control unit 410 generates a third controller C₃=C₀+RL*₃ including the reinforcement learner RL*₃ that corresponds to the result of merging the basic controller C₀ and the first reinforcement learner RL₁^{fix}, the second reinforcement learner RL₂^{fix}, and the third reinforcement learner RL₃^{fix} with each other.

Accordingly, in the third reinforcement learning, the control unit 410 is capable of performing the action that is not more than a certain distance away from the action obtained by the second controller, and avoiding an inappropriate action. The control unit 410 is capable of generating the third controller that is capable of determining the appropriate greedy action and appropriately controlling the environment 110 rather than the second controller generated by the second reinforcement learning while avoiding an inappropriate action. The control unit 410 is capable of reducing the number of reinforcement learners included in the third controller, and reducing the processing amount required when the greedy action is determined by the third controller.

The control unit 410 may repeatedly perform the third reinforcement learning in the action range smaller than the action range limit based on the greedy action obtained by the third controller generated by the third reinforcement learning performed immediately before. The third reinforcement learning after the second time is a series of processes for generating the new third controller that is capable of further determining the greedy action determined to be optimum rather than the third controller generated immediately before by performing the action a plurality of times by using the new third reinforcement learner. The third reinforcement learning after the second time learns the third reinforcement learner, combines the third reinforcement learner with the third controller generated immediately before, and generates the new third controller.

Here, the third reinforcement learner is a control rule for determining the action that is the correction amount for the greedy action obtained by the third controller generated immediately before by using the state action value function within the action range based on the greedy action obtained by the third controller generated immediately before. The third reinforcement learner is used for searching how to correct the greedy action obtained by the third controller generated immediately before during the learning, and determines the search action that is a correction amount for the greedy action obtained by the third controller generated immediately before, The third reinforcement learner determines the greedy action that maximizes the value of the state action value function whenever the learning is completed and fixed.

The control unit 410 determines the search action that is the correction amount of the action in the action range smaller than the action range limit based on the greedy action determined to be optimum by the third controller generated immediately before by using the new third reinforcement learner at regular intervals. The control unit 410 corrects the greedy action determined to be optimum by the third controller generated immediately before with the determined search action, determines the action on the environment 110, and performs the determined action. The control unit 410 observes the reward that corresponds to the search action. The control unit 410 learns the third reinforcement learner based on the observation result, and fixes the third reinforcement learner as the learning is completed. The control unit 410 newly generates the third controller by further merging the learned third reinforcement learner with the reinforcement learner merged with the reinforcement learner learned in the past and included in the third controller generated immediately before. The third controller includes the basic controller and the reinforcement learner obtained by merging the reinforcement learner learned in the past and the learned third reinforcement learner with each other.

Specifically, the control unit 410 performs the reinforcement learning after the fourth reinforcement learning which will be described later in FIG. 5. The control unit 410 determines the search action from the action range for the perturbation based on the greedy action obtained by the (j−1)th controller Cⱼ₋₁=C₀+RL*ⱼ₋₁ generated immediately before by using the j-th reinforcement learner RLⱼ at regular intervals. Each time the control unit 410 determines the search action, the control unit 410 performs the action on the environment 110 based on the determined search action, and observes the reward that corresponds to the search action. The control unit 410 learns the j-th reinforcement learner RLⱼ based on the reward for each search action observed as a result of performing the action a plurality of times, and fixes the j-th reinforcement learner RLⱼ as the learning is completed. The control unit 410 further merges the fixed j-th reinforcement learner RLⱼ^{fix} with the merged reinforcement learner RL*ⱼ₋₁ included in the (j−1)th controller Cⱼ₋₁=C₀+RL*ⱼ₋₁ generated immediately before. As a result, the control unit 410 generates the j-th controller Cⱼ=C₀+RL*ⱼ including the reinforcement learner RL*ⱼ that corresponds to the result of merging the basic controller C₀ and the reinforcement learners from the first reinforcement learner RL₁^{fix} to the j-th reinforcement learner RLⱼ^{fix} with each other.

Accordingly, in the third reinforcement learning after the second time, the control unit 410 is capable of performing the action that is not more than a certain distance away from the action obtained by the third controller learned immediately before, and avoiding an inappropriate action. The control unit 410 is capable of newly generating the third controller that is capable of determining the appropriate greedy action and appropriately controlling the environment 110 rather than the third controller learned immediately before while avoiding an inappropriate action. The control unit 410 is capable of reducing the number of reinforcement learners included in the third controller which is newly generated, and reducing the processing amount required when the greedy action is determined by the third controller which is newly generated,

Although a case where the control unit 410 does not merge the basic controller and the reinforcement learner has been described here, the embodiment is not limited thereto. For example, there may be a case where the control unit 410 merges the basic controller and the reinforcement learner with each other. Specifically, in a case where the basic controller is expressed by a logical expression, the control unit 410 may merge the basic controller and the reinforcement learner with each other. In the following description, a case where the basic controller and the reinforcement learner are merged with each other will be described.

In this case, for example, when the first reinforcement learning is performed, the control unit 410 generates the first controller by merging the first reinforcement learner fixed as the learning is completed with the basic controller. The first controller includes a new reinforcement learner obtained by merging the basic controller and the first reinforcement learner with each other. Specifically, when the first reinforcement learner RL_{I} is fixed as the learning is completed, the control unit 410 merges the basic controller C₀ and the fixed first reinforcement learner RL₁^{fix} with each other. As a result, the control unit 410 generates the first controller C₁=C*₁ including a new reinforcement learner C*₁ obtained by merging the basic controller C₀ and the first reinforcement learner RL₁^{fix} with each other.

Accordingly, in the first reinforcement learning, the control unit 410 is capable of performing the action that is not more than a certain distance away from the action obtained by the basic controller, and avoiding an inappropriate action. The control unit 410 is capable of generating the first controller that is capable of determining the appropriate greedy action and appropriately controlling the environment 110 rather than the basic controller while avoiding an inappropriate action. Since control unit 410 merges the basic controller and the first reinforcement learner with each other, it is possible to reduce the processing amount required when determining the greedy action by the first controller.

For example, when the second reinforcement learning is performed, the control unit 410 generates the second controller by merging the second reinforcement learner fixed as the learning is completed with the first controller. The second controller includes a new reinforcement learner obtained by merging the basic controller, the first reinforcement learner, and the second reinforcement learner with each other. Specifically, when the second reinforcement learner RL₂ is fixed as the learning is completed, the control unit 410 merges the first controller C₁=C*₁ and the fixed second reinforcement learner RL₂^{fix} with each other. As a result, the control unit 410 generates the second controller C₂=C*₂ including a new reinforcement learner C*₂ obtained by merging the first controller C₁=C*_{I} and the fixed second reinforcement learner RL₂^{fix} with each other.

Accordingly, in the second reinforcement learning, the control unit 410 is capable of performing the action that is not more than a certain distance away from the action obtained by the first controller, and avoiding an inappropriate action. The control unit 410 is capable of generating the second controller that is capable of determining the appropriate greedy action and appropriately controlling the environment 110 rather than the first controller generated by the first reinforcement learning while avoiding an inappropriate action. The control unit 410 is capable of reducing the number of reinforcement learners included in the second controller, and reducing the processing amount required when the greedy action is determined by the second controller.

For example, when the third reinforcement learning is performed for the first time, the control unit 410 generates the third controller by merging the third reinforcement learner fixed as the learning is completed with the second controller. The third controller includes a new reinforcement learner obtained by merging the basic controller and the first reinforcement learner, the second reinforcement learner, and the third reinforcement learner with each other. Specifically, when the third reinforcement learner RL₃ is fixed as the learning is completed, the control unit 410 merges the second controller C₂=C*₂ and the fixed third reinforcement learner RL₃^{fix} with each other. As a result, the control unit 410 generates the third controller C₃=C*₃ including a new reinforcement learner C*₃ obtained by merging the second controller C₂=C*₂ and the fixed third reinforcement learner RL₃^{fix} with each other.

Accordingly, in the third reinforcement learning, the control unit 410 is capable of performing the action that is not more than a certain distance away from the action obtained by the second controller, and avoiding an inappropriate action. The control unit 410 is capable of generating the third controller that is capable of determining the appropriate greedy action and appropriately controlling the environment 110 rather than the second controller generated by the second reinforcement learning while avoiding an inappropriate action. The control unit 410 is capable of reducing the number of reinforcement learners included in the third controller, and reducing the processing amount required when the greedy action is determined by the third controller.

For example, when the third reinforcement learning after the second time is performed, the control unit 410 generates the new third controller by merging the third reinforcement learner fixed as the learning is completed by the third reinforcement learning performed this time with the third controller generated immediately before. Here, the third controller includes a new reinforcement learner obtained by merging the basic controller and various reinforcement learners learned in the past with each other. Specifically, when the j-th reinforcement learner RLⱼ is fixed as the learning is completed, the control unit 410 merges the (j−1)th controller Cⱼ₋₁=C*ⱼ₋₁ and the fixed j-th reinforcement learner RLⱼ^{fix} with each other. As a result, the control unit 410 generates the j-th controller Cⱼ=C*ⱼ including a new reinforcement learner C*ⱼ obtained by merging the (j−1)th controller Cⱼ₋₁=C*ⱼ₋₁ and the fixed j-th reinforcement learner RLⱼ^{fix} with each other.

Accordingly, in the third reinforcement learning after the second time, the control unit 410 is capable of performing the action that is not more than a certain distance away from the action obtained by the third controller learned immediately before, and avoiding an inappropriate action. The control unit 410 is capable of newly generating the third controller that is capable of determining the appropriate greedy action and appropriately controlling the environment 110 rather than the third controller learned immediately before while avoiding an inappropriate action. The control unit 410 is capable of reducing the number of reinforcement learners included in the third controller which is newly generated, and reducing the processing amount required when the greedy action is determined by the third controller which is newly generated,

(Description of Various Processes Performed by Each Functional Unit from Setting Unit 411 to Output Unit 416)

Next, various processes performed by each functional unit from the setting unit 411 to the output unit 416 that function as an example of the control unit 410 and realize the first reinforcement learning, the second reinforcement learning, and the third reinforcement learning, will be described.

In the following description, the state of the environment 110 is defined by the following equation (1). vec{s} is a symbol that represents the state of the environment 110. vec{s} is represented with a subscript T in a case of clearly indicating the state of the environment 110 at time point T. The vectors are expressed by using vec{ } for convenience in the sentence. The vectors are expressed with→at the upper part in the drawing and in the equations. The hollow character R is a symbol that represents a real space. The superscript of R is the number of dimensions. vec{s} is n dimensional. s₁, . . . , and sₙ are elements of vec{s}.

s̅=(s₁, . . . , sₙ) ∈ S ⊂ [symbol] ⁿ (1)

In the following description, the action obtained by the reinforcement learner is defined by the following equation (2). vec{a} is a symbol that represents the action obtained by the reinforcement learner. vec{a} is m dimensional. a₁, . . . , and aₘ are elements of vec{a}. vec{a} is expressed by a subscript i in a case of clearly indicating that the action is obtained by the i-th reinforcement learner RLᵢ. vec{a} is expressed by a subscript T in a case of clearly indicating that the action is at time point T. vec{aᵢ} is m, dimensional. a₁, . . . , and aₘᵢ are elements of vec{aᵢ}.

α̅=(α₁, . . . , αₘ) ∈ A ⊂ [symbol] ^{m} (2)

In the following description, an action on the environment 110 determined based on the action vec{aᵢ} obtained by the i-th reinforcement learner RLᵢ is defined by the following equation (3). vec{α} is a symbol that represents an action on the environment 110. vec{α} is expressed by a subscript T in a case of clearly indicating that the action is with respect to the environment 110 at time point T. vec{α} is M dimensional. mᵢ≤M is satisfied. α₁, . . . , and α_{M} are elements of vec{a}.

α̅=(α₁, . . . , α_{M}) ∈ [symbol] ⊂ [symbol] ^{M} (3)

In a case where mᵢ<M, in order to determine the action vec{α}, the action vec{aᵢ} obtained by the i-th reinforcement learner RLᵢ extends to the M dimension by using a function. The function used in a case where mᵢ<M is expressed as ψᵢ. The action extended to the M dimension is expressed as vec{a′ᵢ}. vec{a′ᵢ} is ψᵢ(vec{aᵢ}). vec{a′ᵢ} is M dimensional. In a case where mᵢ=M, vec{a′ᵢ}=vec{aᵢ} may be used.

In the following description, the reward from the environment 110 is defined by the following expression (4). r is a scalar value. r is expressed by a subscript T in a case of clearly indicating that the reward is from the environment 110 at time point T.

r ∈ [symbol] (4)

In the following description, the greedy action obtained by the basic controller C₀ is represented as vec{a′₀}. In the following description, an action obtained by correcting the greedy action vec{a′₀} by the actions vec{a₁} to the action vec{aᵢ} is expressed as vec{a″₀}.

In a case where there is a constraint on the action vec{α}, the action vec{a″ᵢ} or the action vec{b″ᵢ} is corrected by using a function in order to determine the action vec{α}. The constraint is, for example, an upper limit constraint, a lower limit constraint, an upper/lower limit constraint, or an action range constraint. The function used in a case where there is a constraint is expressed as ξᵢ. vec{b″ᵢ} is ξᵢvec{a₀}+vec{a₁}) in a case where i=1, vec{b″ᵢ} is ξ(vec{bᵢ₋₁}+vec{a′ᵢ}) in a case where i≥2. vec{b″ᵢ} is M dimensional. An action obtained by correcting the action vec{a″ᵢ} is represented as vec{a′″ᵢ}. vec{a′″ᵢ} is M dimensional. a′″ indicates a triple dash of a.

In the following description, the state action value function used by the reinforcement learner is defined by the following equation (5). Q(vec{s}, vec{a}) is a symbol that represents the state action value function. The value of the state action value function for the state vec{s_{T}} and the action vec{a_{T}} at time point T is obtained by Q (vec{s_{T}}, vec{a_{T}}). ωₖ is a coefficient that expresses the state action value function, φₖ(vec{s}, vec{a}) is a symbol hat represents a feature amount.

$$Q ( \vec{s} , \vec{a} ) = {\sum }_{k} {ω}_{k} {Φ}_{k} ( \vec{s} , \vec{a} ) ∈ ( ℝ [ \vec{s} ] ) [ \vec{a} ] where {ω}_{k} ∈ ℝ \qquad ( 5 )$$

φₖ(vec{s} vec{a}) is defined by the following equation (6), ζₖ(vec{s}) is a symbol that represents a polynomial.

Φₖ(\vec{s}, \vec{α})=ζₖ(\vec{s})α^{\vec{α}}^{ₖ} where \vec{d}ₖ ∈ [symbol] _{≥0}^{m} (6)

ζₖ(vec{s}) defined by the following equation (7),

ζₖ(\vec{s}) ∈ [symbol] [s₁, . . . , sₙ]= [symbol] [\vec{s}] (7)

âvec{e} is defined by the lowing equation (8).

α^{\vec{e}}:=α₁^{e}^{₁} . . . αₘ^{e}^{ₘ} ∈ [symbol] [α₁, . . . , αₘ] where ē=(e₁, . . . , eₘ) ∈ [symbol] _{≥0}^{m} (8)

In the following description, the latest controller is represented as C. The latest controller C is updated to the j-th controller C when the basic controller C₀ is initially set and then the j-th reinforcement learning is performed.

The setting unit 411 sets variables or the like used by each processing unit. For example, the setting unit 411 initializes T with 0. For example, the setting unit 411 initializes j with 1. The setting unit 411 updates j←j+1 when the j-th reinforcement learning ends. For example, the setting unit 411 performs initialization with C←C₀. When the j-th reinforcement learning is performed, the setting unit 411 sets the reinforcement learner RLⱼ that is used and learned by the j-th reinforcement learning. The setting unit 411 updates C←Cⱼ when the j-th reinforcement learning ends. Accordingly, the setting unit 411 is capable of using the variables for each processing unit.

The state acquisition unit 412 acquires the state vec{s} of the environment 110 every predetermined time during the j-th reinforcement learning, and stores the acquired state vec{s} in the storage unit 400. For example, the state acquisition unit 412 observes the state vec{s_{T}} of the environment 110 at the current time point T every predetermined time, and stores the observed state vec{s_{T}} in the history table 300 in association with ti e point T. Accordingly, the state acquisition unit 412 is capable of causing the action determination unit 413 or the update unit 415 to refer to the state vec{S_{T}} of the environment 110.

The action determination unit 413 determines the search action vec{aⱼ} by the j-th reinforcement learner RLⱼ during the j-th reinforcement learning, and determines the action vec{α} on the environment 110 actually performed based on the search action vec{aⱼ}. The action determination unit 413 stores the search action vec{aⱼ} and the action vec{α} on the environment 110 in the storage unit 400.

For example, there is a case where mⱼ=M and there is no constraint on the action vec{α}. In this case, the action determination unit 413 specifically determines C(vec{s_{T}})=C₀(vec{s_{T}})+RL*ⱼ₋₁(vec{s_{T}}). According to this, the action determination unit 413 is capable of practically determining vec{a′₀}+vec{a′₁}+ . . . +vec{a′ⱼ₋₁}, Next, the action determination unit 413 determines RLⱼ(vec{s_{T}})=vec{aⱼ}=vec{a′ⱼ}. The action determination unit 413 determines vec{α}=vec{a″ⱼ}=C(vec{s_{T}})+RLⱼ(vec{s_{T}}). According to this, the action determination unit 413 is capable of practically determining vec{α}=vec{a″ⱼ}=vec{a′₀}+vec{a′₁}+ . . . +vec{a′ⱼ₋₁}+vec{a′ⱼ}.

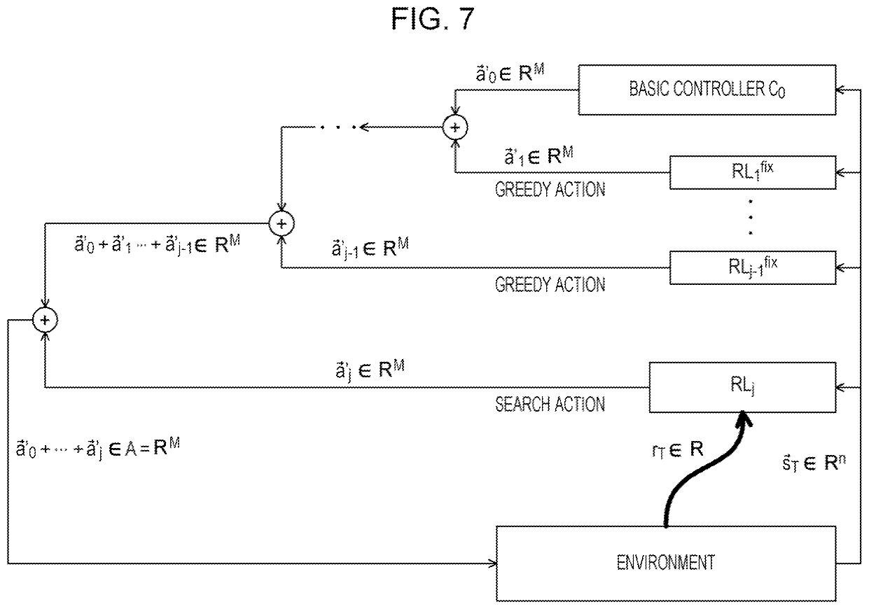

Thereafter, the action determination unit 413 stores the action vec{α} on the environment 110 and the search action RLⱼ(vec{s_{T}})=vec{aⱼ}=vec{a′ⱼ} in the history table 300. More specifically, a case where mⱼ=M and there is no constraint on the action vec{α} will be described later with reference to FIG. 7, for example.

Accordingly, the action determination unit 413 is capable of determining a preferable action on the environment 110, and efficiently controlling the environment 110. When determining the action vec{α} on the environment 110, the action determination unit 413 may calculate the reinforcement learners RL*ⱼ₋₁, and is capable of reducing the processing amount without calculating the reinforcement learners RL₁ to RLⱼ₋₁ one by one.

For example, there is a case where mⱼ<M and there is no constraint on the action vec{α}. In this case, the action determination unit 413 specifically determines C(vec{s_{T}})=C₀(vec{s_{T}})+RL*ⱼ₋₁(vec{s_{T}}). According to this, the action determination unit 413 is capable of practically determining vec{a′₀}+vec{a′₁}+ . . . +vec{a′ⱼ₋₁}=vec{a′₀}+ψ₁(vec{a₁})+ . . . +ψⱼ₋₁(vec{aⱼ₋₁}). Next, the action determination unit 413 determines ψⱼ(RLⱼ(vec{s_{T}}))=ψⱼ(vec{aⱼ})=vec{a′ⱼ}. The action determination unit 413 determines vec{α}=vec{a″ⱼ}C(vec{s_{T}})+ψⱼRLⱼ(vec{s_{T}})). According to this, the action determination unit 413 is capable of practically determining vec{α}=vec{a″}=vec{a′₀}+vec{a′₁}+ . . . +vec{a′ⱼ₋₁}+vec{a′ⱼ}=vec{a′₀}+ψ₁(vec{a₁})+. . . +ψⱼ₋₁(vec{ⱼ₋₁})+ψⱼ(vec{aⱼ}).

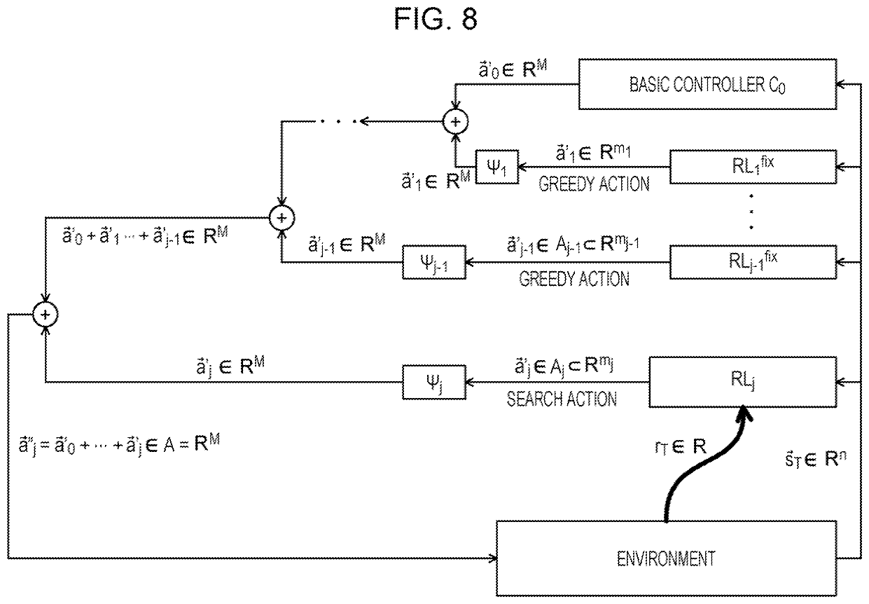

Thereafter, the action determination unit 413 stores the action vec{α} on the environment 110 and the search action RLⱼ(vec{s_{T}})=vec{aⱼ} in the history table 300. More specifically, a case where mⱼ<M and there is no constraint on the action vec{α} will be described later with reference to FIG. 8, for example.

Accordingly, the action determination unit 413 is capable of determining a preferable action on the environment 110, and efficiently controlling the environment 110. When determining the action vec{α} on the environment 110, the action determination unit 413 may calculate the reinforcement learners RL*ⱼ₋₁, and is capable of reducing the processing amount without calculating the reinforcement learners RL₁ to RLⱼ₋₁ one by one.

For example, there is a case where mⱼ<M and there is constraint on the action vec{α}. In this case, the action determination unit 413 specifically determines C(vec{s_{T}})=C*ⱼ₋₁(vec{s_{T}})=vec{b″ⱼ₋₁}. According to this, the action determination unit 413 is capable of practically determining ξⱼ₋₁( . . . ξ₁(vec{a′₀}+vec{a′₁}) . . . +vec{a′ⱼ₋₁}). Next, the action determination unit 413 determines ψⱼ(RLⱼ(vec{s_{T}}))=ψⱼ(vec{aⱼ})=vec{a′ⱼ}. The action determination unit 413 determines vec{α}=vec{b″ⱼ}=ξⱼ(C(vec{s_{T}})+ψⱼ(RLj(vec{s_{T}}))). According to this, action determination unit 413 is capable of practically determining vec{α}=vec{b″ⱼ}=ξⱼ(ξⱼ₋₁( . . . ξ₁(vec{a′₀}+vec{a′₁}) . . . )+vec{a′ⱼ₋₁})+vec{a′_{j}). Here, the basic controller C}_{O} is expressed by a logical expression.

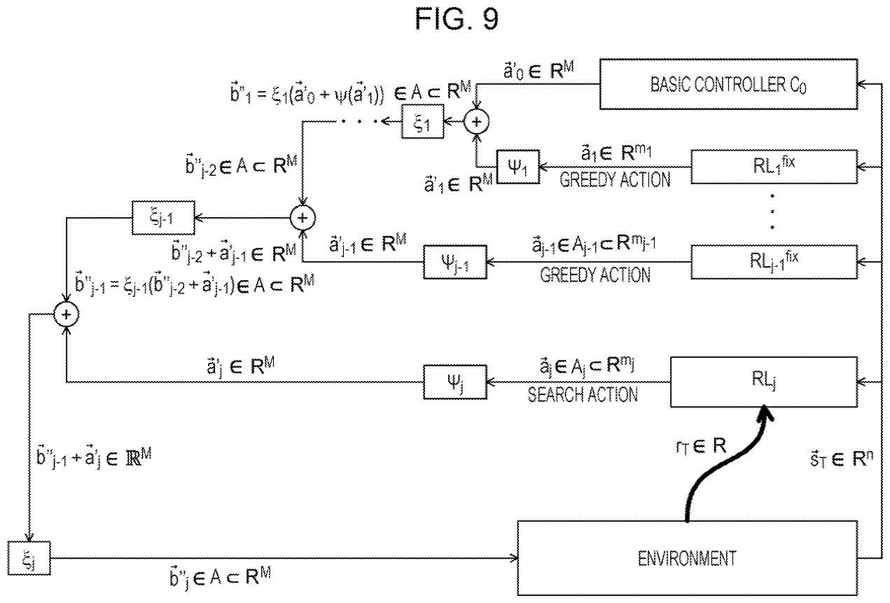

Thereafter, the action determination unit 413 stores the action vec{α} on the environment 110 and the search action RLⱼ(vec(s_{T}))=vec{aⱼ} in the history table 300. More specifically, a case where mⱼ<M and there is a constraint on the action vec{α} will be described later with reference to FIG. 9, for example.

Accordingly, the action determination unit 413 is capable of determining a preferable action on the environment 110, and efficiently controlling the environment 110. The action determination unit 413 may change m) actions, and is capable of reducing the processing amount. When determining the action vec{α} on the environment 110, the action determination unit 413 may calculate the reinforcement learners C*ⱼ₋₁, and is capable of reducing the processing amount without calculating the basic controller C₀ and the reinforcement learners RL₁ to RLⱼ₋₁ one by one.

Here, a case where the action determination unit 413 corrects the action obtained by the basic controller C₀ each time the correction is performed by using the action obtained by the reinforcement learners RL₁ to RLⱼ by using ξ₁ to ξᵢ has been described, but the embodiment is not limited thereto. For example, there may be a case where the action determination unit 413 adds the actions obtained by the reinforcement learners RL₁ to RLⱼ to the action obtained by the basic controller C₀, and then collectively corrects the added action with ξⱼ. According to this, even in a case where the basic controller C₀ is not expressed by a logical expression, the action determination unit 413 is capable of determining the action.

In this case, the action determination unit 413 specifically determines C(vec{s_{T}})=C₀(vec{s_{T}})+RL*ⱼ₋₁(vec{s_{T}}). According to this, the action determination unit 413 is capable of practically determining vec{a′₀}+vec{a′₁}+ . . . +vec{a′ⱼ₋₁})=vec{a′₀}+ψ₁(vec{a₁})+ . . . +ψⱼ₋₁(vec{aⱼ₋₁}). Next, the action determination unit 413 determines ψⱼ(RLⱼ(vec{s_{T}}))=ψⱼ(vec{aⱼ})=vec{a′ⱼ}. The action determination unit 413 determines vec{α}=ξⱼ(vec{a″ⱼ})=ξⱼ(C(vec{s_{T}})+ψⱼ(RLⱼ(vec{s_{T}}))). According to this, the action determination unit 413 is capable of practically determining vec{α}=ξⱼ(vec{a″ⱼ})=ξⱼ(vec{a′₀}+vec{a′₁}+ . . . +vec{a′ⱼ₋₁}+vec{a′ⱼ})=ξⱼ(vec{a′₀}+ψ₁(vec{a₁})+ . . . +ψⱼ₋₁. (vec{aⱼ₋₁})+ψⱼ(vec{aⱼ})).

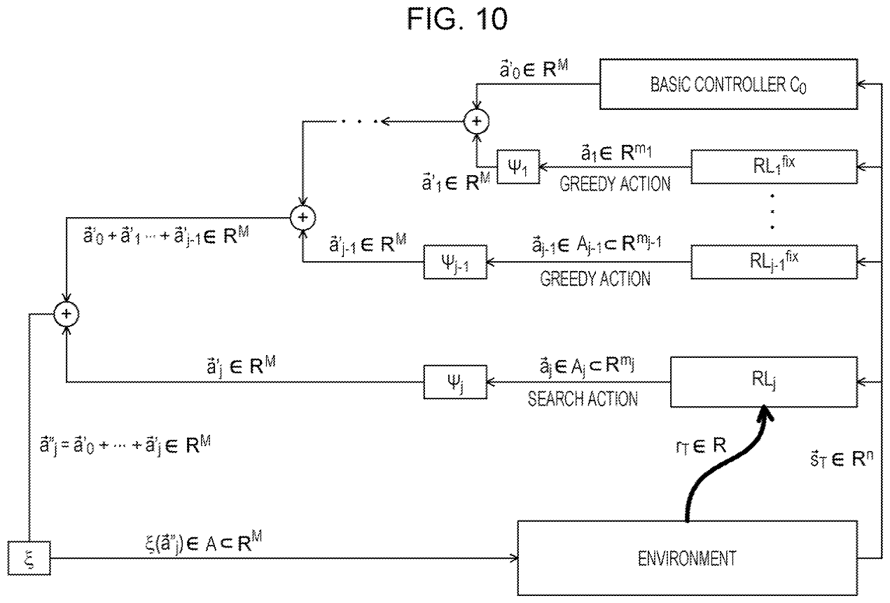

Thereafter, the action determination unit 413 stores the action vec{α} on the environment 110 and the search action RLⱼ(vec{s_{T}})=vec{aⱼ} in the history table 300. More specifically, a case of collectively correcting the action with ξⱼ after adding the actions obtained by the reinforcement learners RL₁ to RLⱼ to the action obtained by the basic controller C₀, will be described later with reference to FIG. 10.

Accordingly, the action determination unit 413 is capable of determining a preferable action on the environment 110, and efficiently controlling the environment 110. The action determination unit 413 may change mⱼ actions, and is capable of reducing the processing amount. When determining the action vec{α} on the environment 110, the action determination unit 413 may calculate the reinforcement learners RL*ⱼ₋₁, and is capable of reducing the processing amount without calculating the reinforcement learners RL₁ to RLⱼ₋₁ one by one.

The reward acquisition unit 414 acquires the reward r that corresponds to the performed action vec{α} each time the action vec{α} is performed when the j-th reinforcement learning is performed, and stores the acquired reward r in the storage unit 400. The reward may be a value obtained by multiplying the cost by a negative value. The reward acquisition unit 414, for example, acquires a reward r_{T+1} from the environment 110 at time point T+1 after a predetermined period of time after the action vec{α_{T}} is performed each time the action vec{α_{T}} is performed, and stores the acquired reward r_{T+1} in the history table 300. Accordingly, the reward acquisition unit 414 is capable of making the update unit 415 refer to the reward.

The update unit 415 learns the reinforcement learner RLⱼ based on the acquired state vec{s}, the search action vec{a}, and the reward r during the j-th reinforcement learning, and fixes the reinforcement learner RLⱼ as the learning is completed. The update unit 415 generates the new controller Cⱼ by combining the fixed reinforcement learner RLⱼ with the controller C=Cⱼ₋₁ which is the latest in the present situation.

The update unit 415 calculates δ_{T} by the following equation (9) or the following equation (10), for example. γ is a discount rate. vec{b} is an action that is capable of maximizing the Q value in the state vec{s_{T+1}},

δ_{T}=r_{T+1}+γQ(s̅_{T}, α̅_{T})−maxQ(s̅_{T+1}, b̅) (9)

δ_{T}=r_{T+1}+γQ(\vec{s}_{T}, \vec{α}_{T})−Q(\vec{s}_{T+1}, \vec{_{T+1}}) (10)

Next, the update unit 415 updates a coefficient array w that represents the state action value function used for the reinforcement learner RLⱼ by the following equation (11) based on the calculated δ_{T}, and makes the reinforcement learner RLⱼ commonly output the greedy action.

ω←ω+αδ_{T}Φ(\vec{s}_{T}, \vec{α}_{T}) (11)

The update unit 415 adds the fixed reinforcement learner RLⱼ to the controller C=Cⱼ₋₁ which is the latest in the present situation, and generates the new controller Cⱼ. At this time, in a case where j=1, the update unit 415 generates the new controller C₁=C₀+RL₁ because the controller C=C₀ is the latest in the present situation. In a case where j=2, the update unit 415 generates the RL*₂ by merging RL₁ and RL₂ with each other because the controller C=C₁=C₀+RL₁ is the latest in the present situation, and generates the new controller C₂=C₀+RL*₂, In a case where j≥3, the update unit 415 generates the RL*ⱼ by merging RL*ⱼ₋₁ and RLⱼ with each other because the controller C=Cⱼ₋₁=C₀+RL*ⱼ₋₁ is the latest in the present situation, and generates the new controller Cⱼ=C₀+RL*ⱼ.

At this time, specifically, the update unit 415 realizes the merging by using the quantifier elimination by the following expressions (12) to (14). Aⱼ is a symbol that represents an action range in which the j-th reinforcement learner determines the search action. Here, vec{a}∈Aⱼ is expressed by a logical expression. A logical expression that expresses vec{a}∈Aⱼ as a logical expression [Aⱼ(vec{a})] for convenience in the sentence. A logical expression that expresses vec{a}∈Aⱼ is represented by adding a bar to the upper part of Aⱼ(vec{a}) in the drawing and in the expressions.

The reinforcement learner RL*ᵢ that corresponds to the result of merging the reinforcement learners from the first reinforcement learner RL₁ to the i-th reinforcement learner RLᵢ is expressed by a logical expression. The logical expression that expresses the reinforcement learner RL*ᵢ is expressed as a logical expression [P″ᵢ(vec{s}, vec{a})] for convenience in the sentence. The logical expression that expresses the reinforcement learner RL*ᵢ is represented by adding a bar to the upper part of P″ᵢ(vec{s}, vec{a}) in the drawing and in the expression. The function ψᵢ is expressed by a logical expression. The logical expression that expresses the function ψᵢ is represented as a logical expression [ψᵢ(vec{a}, vec{a′})] for convenience in the sentence. The logical expression that expresses the function toᵢ is represented by adding a bar to the upper part of ψᵢ(vec{a}, vec{a′}) in the drawing and in the expression. The function QE is a function that performs the quantifier elimination on a real closed body. ∃vec{a} represents ∃a₁, . . . , and ∃aₘ. ∀vec{a} represents ∀a₁, . . . , and ∀aₘ.

P̅ⱼ(\vec{s}, \vec{α})←QE(Āⱼ(\vec{α})̂∀b̅(Āⱼ(b̅)→Qⱼ(\vec{s}, \vec{α})≥Qⱼ(\vec{s}, \vec{b}))) (12)

P̅′ⱼ(\vec{s}, \vec{α}′)←QE(∃\vec{a}(ψ̅ⱼ(\vec{α}, \vec{α}′)̂P̅ⱼ(\vec{s}, \vec{α}))) (13)

P̅″(\vec{s}, \vec{α}″)←QE(∃\vec{α}′∃\vec{b}(P̅′ⱼ(\vec{s}, \vec{α}′)̂P̅″ⱼ₋₁(\vec{s}, \vec{b}) ̂\vec{α}″=\vec{α}′+\vec{b})) (14)

In a case where j=1, the update unit 415 may generate the new controller C₁=C*₁ by merging the first reinforcement learner RL₁ with the controller C=C₀ which is the latest in the present situation when it is possible to express the basic controller C₀ by a logical expression. In a case where j≥2, the update unit 415 may generate the new controller Cⱼ=C*ⱼ by merging the fixed j-th reinforcement learner RLⱼ with the controller C=Cⱼ₋₁=C*ⱼ₋₁ which is the latest in the present situation.

At this time, specifically, the update unit 415 realizes the merging using the quantifier elimination by the following expressions (15) to (18). Here, the new controller C*ᵢ that corresponds to the result of merging the basic controller C₀ and the reinforcement learners from the first reinforcement learner RL₁ to the i-th reinforcement learner RLᵢ to each other, is expressed by a logical expression. The logical expression that expresses the new controller C*ᵢ is represented as a logical expression [Cᵢ(vec{s}, vec{a′″})] for convenience in the sentence. The logical expression that expresses the new controller C*ᵢ is represented by adding a bar to the upper part of [Cᵢ(vec{s}, vec{a′″})] in the drawing and in the expression. The function ξⱼ is expressed by a logical expression. The logical expression that expresses the function ξⱼ is represented as a logical expression [ξⱼ(vec{a″}, vec{a′″})] for convenience in the sentence. The logical expression that expresses the function ξᵢ is represented by adding a bar to the upper part of ξᵢ(vec{a″}, vec{a′″}) in the drawing and in the expression.

P̅ⱼ(\vec{s}, \vec{α})←QE(Āⱼ(\vec{α})̂∀b̅(Āⱼ(b̅)→Qⱼ(\vec{s}, \vec{α})≥Qⱼ(\vec{s}, \vec{b}))) (15)

P̅′ⱼ(\vec{s}, \vec{α}′)←QE(∃\vec{α}(ψ̅ⱼ(\vec{α}, \vec{α}′)̂P̅ⱼ(\vec{s}, \vec{α}))) (16)

P̅″(\vec{s}, \vec{α}″)←QE(∃\vec{α}′\vec{b}(P̅′ⱼ(\vec{s}, \vec{α}′)̂C̅ⱼ₋₁(\vec{s}, \vec{b}) ̂\vec{α}″=\vec{α}′+\vec{b})) (17)

C̅ⱼ(\vec{s}, \vec{α}′″)←QE(∃α̅″(ξⱼ(\vec{α}″, \vec{α}′″) ̂P̅″ⱼ(\vec{s}, \vec{α}″))) (18)

Accordingly, the update unit 415 is capable of generating the new controller with higher accuracy than that of the controller C which is the latest in the present situation during the j-th reinforcement learning, and causing the setting unit 411 to be set as the latest controller C. In this manner, the setting unit 411 to the update unit 415 are capable of realizing the first reinforcement learning, the second reinforcement learning, and the third reinforcement learning which are described above.

The output unit 416 outputs the action vec{α} determined by the action determination unit 413. Accordingly, the output unit 416 is capable of controlling the environment 110. The output unit 416 may output the processing result of each processing unit. Examples of the output format include, for example, display on a display, printing output to a printer, transmission to an external device by the network I/F 203, and storing in a storage region, such as the memory 202 or the recording medium 205. Accordingly, the output unit 416 is capable of notifying the user of the processing result of any of the functional units, and it is possible to improve convenience of the information processing apparatus 100.

(Operation Example of Information Processing Apparatus 100)

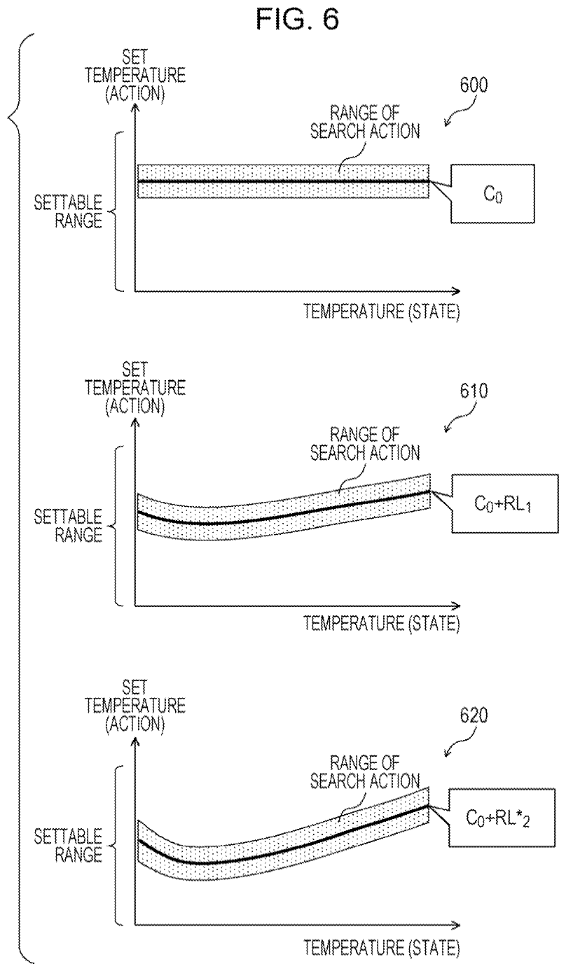

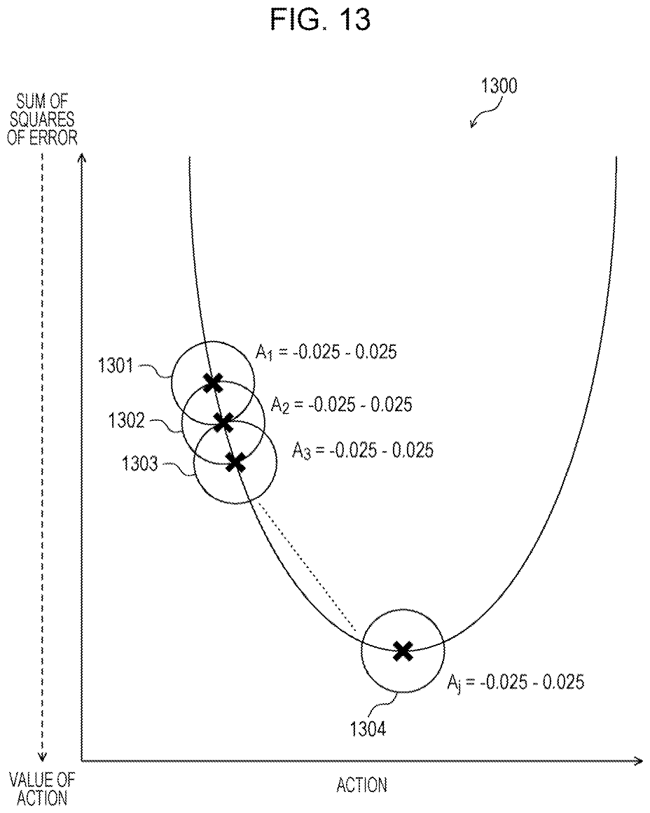

Next, an operation example of the information processing apparatus 100 will be described with reference to FIGS. 5 to 16. In the following description, problem setting for the environment 110 in the operation example will be described first. Next, the flow of operations in which the information processing apparatus 100 repeats the reinforcement learning will be described with reference to FIGS. 5 and 6. The details of the j-th reinforcement teaming will be described with reference to FIGS. 7 to 12. Next, effects obtained by the information processing apparatus 100 will be described with reference to FIGS. 13 to 16.

(Problem Setting for Environment 110 in Operation Example)

First, the problem setting for the environment 110 in the operation example will be described. For the environment 110, for example, a problem of maximizing the discount accumulated reward or the average reward for the purpose of maximizing the discount accumulated reward or the average reward in the environment 110 is set For example, when a value obtained by multiplying the cost by a negative value is treated as a reward, it is possible to practically set a cost minimization problem for the environment 110 as a maximization problem,

In the following description, the problem of maximizing the discount accumulated reward or the average reward in which the set temperature of the air conditioning equipment in a room that serves as the environment 110 is considered as an action, the sum of squares of the error between the target room temperature and the actually measured room temperature is considered as the cost, and the value obtained by multiplying the cost by a negative value is considered as the cost, will be described. The state is, for example, an outside temperature of the room that serves as the environment 110. Various variables and various functions that represent the maximization problem are the same as the various variables and various functions used in the description above.

(Flow of Operations for Repeating Reinforcement Learning)

Next, with reference to FIG. 5, the flow of the operations in which the information processing apparatus 100 repeats the reinforcement learning regarding the above-described maximization problem will be described,

FIG. 5 is an explanatory diagram illustrating a flow of the operations for repeating the reinforcement learning. A table 500 in FIG. 5 illustrates a schematic diagram in a case where the information processing apparatus 100 repeats the reinforcement learning based on outside air temperature data for one day.

As illustrated in FIG. 5, in the first reinforcement learning, the information processing apparatus 100 determines the search action to be perturbed from the action range 501 for the perturbation based on the greedy action by the basic controller C₀ by using the first reinforcement learner RL₁. Next, the information processing apparatus 100 corrects the greedy action by the basic controller C₀ with the determined search action, determines the action on the environment 110, and performs the determined action on the environment 110. The information processing apparatus 100 generates the first controller C₁=C₀+RL₁ that is capable of determining the appropriate greedy action by the basic controller C₀.

Accordingly, the information processing apparatus 100 is capable of stopping the action outside the action range 501 for the perturbation from being determined as the action on the environment 110 based on the greedy action by the basic controller C₀. As a result, the information processing apparatus 100 is capable of performing the first reinforcement learning while avoiding an inappropriate action that adversely affects the environment 110,

Here, a case of determining the search action to be perturbed from an unlimited range or a relatively wide action range 510 based on the greedy action by the basic controller C₀, is considered. In this case, the action value is low, and an inappropriate action that adversely affects the environment 110 is likely to be performed. For example, when an action 511 is an inappropriate action, a possibility that the action 511 is performed in a case where the search action is determined from the action range 510. Meanwhile, the information processing apparatus 100 is capable of avoiding the action 511 in the first reinforcement learning.

In the second reinforcement learning, the information processing apparatus 100 determines the search action to be perturbed from an action range 502 for the perturbation based on the greedy action by the first controller C₁=C₀+RL₁ by using the second reinforcement learner RL₂. Next, the information processing apparatus 100 corrects the greedy action by the first controller C₁=C₀+RL₁ with the determined search action, determines the action on the environment 110, and performs the action on the environment 110. The information processing apparatus 100 generates the second controller C₂=C₀+RL*₂ by merging the second reinforcement learner RL₂ with the first reinforcement learner RL₁ included in the first controller C₁=C₀+RL₁.

In the third reinforcement learning, the information processing apparatus 100 determines the search action to be perturbed from an action range 503 for the perturbation based on the greedy action by the second controller C₂=C₀+RL*₂ by using the third reinforcement learner RL₃. Next, the information processing apparatus 100 corrects the greedy action by the second controller C₂=C₀+RL*₂ with the determined search action, determines the action on the environment 110, and performs the action on the environment 110. The information processing apparatus 100 generates the third controller C₃=C₀+RL*₃ by merging the third reinforcement learner RL₃ with the reinforcement learner RL*₂ included in the second controller C₂=C₀+RL*₂.

In the fourth reinforcement learning, the information processing apparatus 100 determines the search action to be perturbed from an action range 504 for the perturbation based on the greedy action by the third controller C₃=C₀+RL*₃ by using the fourth reinforcement learner R₄. Next, the information processing apparatus 100 corrects the greedy action by the third controller C₃=C₀+RL*₃ with the determined search action, determines the action on the environment 110, and performs the action on the environment 110. The information processing apparatus 100 generates the fourth controller C₄=C₀+RL*₄ by merging the fourth reinforcement learner RL₄ with the reinforcement learner RL*₃ included in the third controller C₃=C₀+RL*₃.

In the fifth reinforcement learning, the information processing apparatus 100 determines the search action to be perturbed from an action range 505 for the perturbation based on the greedy action by the fourth controller C₄=C₀+RL*₄ by using the fifth reinforcement learner RL₅. Next, the information processing apparatus 100 corrects the greedy action by the fourth controller C₄=C₀+RL*₄ with the determined search action, determines the action on the environment 110, and performs the action on the environment 110. The information processing apparatus 100 generates the fifth controller C₅C₀+RL*₅ by merging the fifth reinforcement learner RL₅ with the reinforcement learner RL*₄ included in the fourth controller C₄=C₀+RL*₄.

Similarly, the information processing apparatus 100 repeats the sixth and subsequent reinforcement learning. For example, in the j-th reinforcement learning, the information processing apparatus 100 determines the search action to be perturbed from an action range 506, corrects the greedy action with the search action, and determines the action on the environment 110.

Accordingly, in the i-th reinforcement learning, the information processing apparatus 100 is capable of stopping the action outside the action range for the perturbation from being determined as the action on the environment 110 based on the greedy action by the latest controller Cᵢ₋₁. As a result, the information processing apparatus 100 is capable of performing the i-th reinforcement learning while avoiding an inappropriate action that adversely affects the environment 110.

Here, each time the i-th reinforcement learning with i≥2 is performed, there is a case where the i-th reinforcement learner RLᵢ is added to the (i−1l)th controller Cᵢ₋₁ without merging the i-th reinforcement learner RLᵢ. In this case, in order to determine the greedy action using the j-th controller Cⱼ in the j-th reinforcement learning, the following equation (19) is solved.

$${C}_{j} ( \vec{s} ) = ξ ( {C}_{0} ( \vec{s} ) + {\sum }_{j} {ψ}_{j} ( {RL}_{j} ( \vec{s} ) ) ) = ξ ( {C}_{0} ( \vec{s} ) + {\sum }_{j} {ψ}_{j} ( {argmax}_{\vec{a} ∈ {A}_{j}} {Q}_{j} ( \vec{s} , \vec{a} ) ) ) \qquad ( 19 )$$

As illustrated in the above-described equation (19), when the merging is not performed, in order to determine the greedy action by using the j-th controller Cⱼ, the reinforcement learners from the first reinforcement learner RL₁ to the j-th reinforcement learner RLⱼ are calculated one by one, and an increase in processing amount is caused. Meanwhile, each time the i-th reinforcement learning with i≥2 is performed, the information processing apparatus 100 is capable of adding the i-th reinforcement learner RLᵢ to the (i−1)th controller Cᵢ₋₁ by performing the merging. Therefore, when the information processing apparatus 100 determines the greedy action by using the j-th controller Cⱼ, the information processing apparatus 100 may calculate the reinforcement learner RL*ⱼ and is capable of suppressing an increase in the processing amount.

(Changes in Action Range that Determines Search Action)

Next, how the action range for determining the search action changes in a case where the information processing apparatus 100 repeats the reinforcement learning will be specifically described with reference to FIG. 6.

FIG. 6 is an explanatory diagram illustrating a change in the action range far determining the search action. Each graph 600 to 620 in FIG. 6 represents an example of the greedy action on the state of the environment 110. Here, the basic controller C₀ is a fixed controller in which the greedy action on the state is linear in order to control the set temperature to a certain level,

For example, in the first reinforcement learning, the information processing apparatus 100 determines the search action to be perturbed from the action range for the perturbation graph on the greedy action obtained by the basic controller C₀ as illustrated in the table 600, and learns the reinforcement learner RL₁. The information processing apparatus 100 generates a first controller C₁=C₀+RL₁ by combining the basic controller C₀ and the reinforcement learner RL₁ with each other. Accordingly, the information processing apparatus 100 is capable of generating the first controller C₁=C₀+RL₁ that is capable of expressing the greedy action on each state of the environment 110 in a more flexible manner rather than in a straight line. As illustrated in a graph 610, the first controller C₀+RL₁ is capable of expressing the greedy action on the state in a curved line, and is capable of expressing the appropriate greedy action on each state of the environment 110.

For example, in the second reinforcement learning, the information processing apparatus 100 determines the search action to be perturbed from the action range for the perturbation based on the action determined by the first controller C₁=C₀+RL₁ as illustrated in the graph 610, and learns the reinforcement learner RL₂. The information processing apparatus 100 generates the second controller C₂=C₀+RL*₂ by combining the first controller C₁=C₀+RL₁ and the reinforcement learner RL₂ with each other. Accordingly, the information processing apparatus 100 is capable of generating the second controller C₂=C₀+RL*₂ that is capable of expressing the greedy action on each state of the environment 110 in a more flexible manner. As illustrated in a graph 620, the second controller C₂=C₀+RL*₂ is capable of expressing the greedy action on the state in a curved line, and is capable of expressing the appropriate greedy action on each state of the environment 110.

For example, in the third reinforcement learning, the information processing apparatus 100 determines the search action to be perturbed from the action range for the perturbation based on the action determined by the second controller C₂=C₀+RL*₂ as illustrated in the graph 620, and learns the reinforcement learner RL₃. The information processing apparatus 100 generates the third controller C₃=C₀ RL*₃ by combining the second controller C₂=C₀+RL*₂ and the reinforcement learner RL₃ with each other. Accordingly, the information processing apparatus 100 is capable of generating the third controller C₃=C₀+RL*₃ that is capable of expressing the greedy action on each state of the environment 110 in a more flexible manner. The third controller C₃=C₀+RL*₃ is capable of expressing the greedy action on the state in a curved line, and is capable of expressing the appropriate greedy action on each state of the environment 110.

In this manner, the information processing apparatus 100 is capable of repeating the reinforcement learning while gradually moving the action range for determining the search action taken for each state of the environment 110. The information processing apparatus 100 is capable of generating the controller such that the appropriate action is capable of determining for each state, and is capable of controlling the environment 110 with high accuracy while avoiding an inappropriate action.

(Details of j-th Reinforcement Learning)

Next, the details of the j-th reinforcement learning will be described with reference to FIGS. 7 to 12. In the examples of FIGS. 7 to 12, a case of the environment 110 in which twenty air conditioning equipment of which the set temperatures are changeable, is taken as an example. Therefore, M is 20.

FIG. 7 is an explanatory diagram illustrating the details of the j-th reinforcement learning in a case where mⱼ=M and there is no action constraint. In a case where mⱼ=M, for example, there is a case where it is possible to add the search action vec{aⱼ}=vec{a′ⱼ} to be perturbed into all elements of the M dimensional greedy action vec{a″ⱼ₋₁} obtained by the latest controller C by the j-th reinforcement learner RLⱼ.

In this case, an example of the action range of the search action vec{aⱼ} is expressed as a following expression (20) when being expressed by a logical expression. Specifically, an element a, of the search action vec{aⱼ} is included in the action range from −10 to 10.

Āⱼ(α̅)≡̂ₓ₌₁²⁰(−10≤αₓ≤10) (20)

In this case, since the search action is vec{aⱼ}=vec{a′ⱼ}, the function ψⱼ for converting vec{aⱼ} to vec{a′ⱼ} is expressed as the following expression (21) when being expressed by a logical expression. Therefore, the function ψⱼ is not practically used.

ψ̅ⱼ(\vec{α}, \vec{α}″)≡(α′₁=α₁ ̂ . . . ̂ α′₂₀=α₂₀) (21)

As illustrated in FIG. 7, in the j-th reinforcement learning, the sum of the greedy action vec{a₀}, the greedy action vec{aᵢ} with j>i≥1, and the search action vec{aⱼ} may be set as the action vec{α} on the environment 110. The greedy action vec{a₀} is obtained by the basic controller C₀ based on the state vec{s_{T}} of the environment 110. The greedy action vec{aᵢ} with j>i≥1 is obtained by the i-th reinforcement learner RLᵢ based on the state vec{s_{T}} of the environment 110. The search action vec{aⱼ} is obtained by the j-th reinforcement learner RLⱼ.

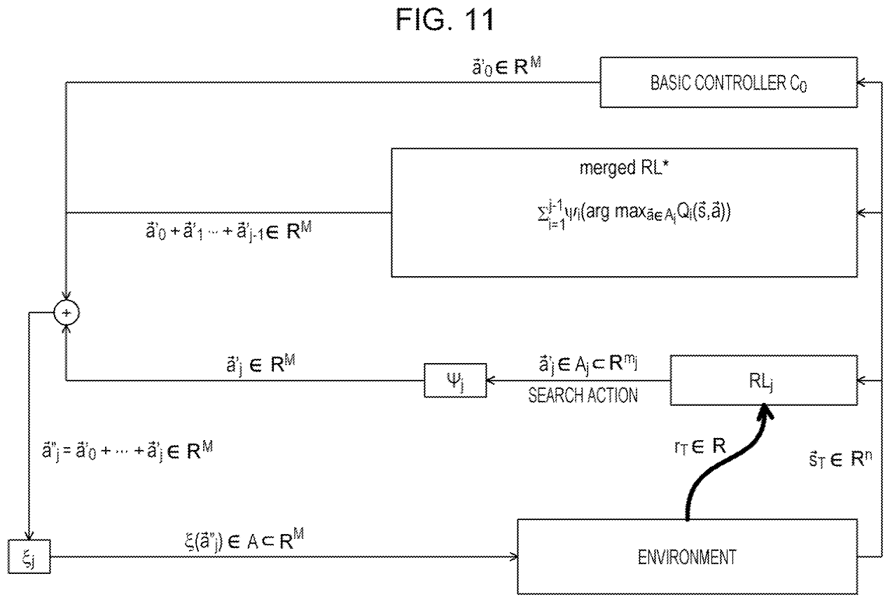

Here, as described above, when the merging is not performed, in the j-th reinforcement learning, the greedy action vec{aᵢ} of j−1≥i≥1 is calculated one by one, and an increase in the processing amount is caused. Therefore, the information processing apparatus 100 preferably merges the reinforcement learners from the first reinforcement learner RL₁ to the (j−1)th reinforcement learner RLⱼ₋₁. A specific example of merging will be described later with reference to FIG. 11.

FIG. 8 is an explanatory diagram illustrating details of the j-th reinforcement learning in a case where mⱼ<M and there is no action constraint. A case where mⱼ<M is, for example, a case where some elements of the M dimensional greedy action vec{a″ⱼ₋₁} obtained by the latest controller C by the j-th reinforcement learner RLⱼ, are corrected by using the search action vec{aⱼ} to be perturbed.

In this case, an example of the action range of the search action vec{aⱼ} is expressed as a following expression (22) when being expressed by a logical expression. Specifically, an element aₓ of the search action vec{aⱼ} is included in the action range from −20 to 20. aₓ is a₁, a₂, and a₃.

Āⱼ(α̅)≡̂ₓ₌₁³(−20≤αₓ≤20) (22)

In this case, the function ψⱼ for extending the search action vec{aⱼ} to the M dimension and converting the search action vec{aⱼ} into vec{a′ⱼ} is expressed as the following expression (23) when being expressed by a logical expression.

ψ̅ⱼ(\vec{α}, \vec{α}′)≡(α′₁=α₁ ̂ . . . ̂α′₃=α₃)̂(̂_{y=4}²⁰α′_{y}=0) (23)

Specifically, the above-described expression (22) and the above-described expression (23) mean that the search action vec{aᵢ} is determined for three air conditioning equipment randomly selected from the twenty air conditioning equipment. The search action vec{aⱼ} is not determined for an unselected air conditioning equipment.

According to this, the information processing apparatus 100 is capable of reducing the number of elements aₓ to be determined by the j-th reinforcement learner RLⱼ as the search action vec{aⱼ}, and is capable of suppressing an increase in the number of times of learning in the j-th reinforcement learning. Therefore, the information processing apparatus 100 is capable of reducing the processing amount required for the j-th reinforcement learning.

As illustrated in FIG. 8, in the j-th reinforcement learning, the sum of the greedy action vec{a₀} and the action vec{a′ᵢ} with j≤i≤1 may be set as the action vec{α} on the environment 110. The greedy action vec{a₀} is obtained by the basic controller C₀ based on the state vec{s_{T}} of the environment 110. The action vec{a′ᵢ} with j>i≥1 is obtained by correcting the greedy action vec{aᵢ} with ψᵢ. The greedy action vec{aᵢ} with j>i≥1 is obtained by the i-th reinforcement learner RLᵢ based on the state vec{s_{T}} of the environment 110. The action vec{a′ⱼ} is obtained by correcting the search action vec{a_{T}} by ψⱼ. The search action vec{aⱼ} is obtained by the j-th reinforcement learner RLⱼ.

Here, as described above, when the merging is not performed, in the j-th reinforcement learning, the greedy action vec{aᵢ} of j-1≥i≥1 is calculated one by one, and an increase in the processing amount is caused. Therefore, the information processing apparatus 100 preferably merges the reinforcement learners from the first reinforcement learner RL₁ to the (j−1)th reinforcement learner RLⱼ₋₁. A specific example of merging will be described later with reference to FIG. 11.

Here, a case where the information processing apparatus 100 corrects some elements of the M dimensional greedy action vec{a″ⱼ₋₁} obtained by the latest controller C by using the search action vec{aⱼ} to be perturbed, has been described, but the embodiment is not limited thereto.

For example, there may be a case where the information processing apparatus 100 groups the elements aₓ of the search action vec{aⱼ} and determines the element aₓ to be the same value for each group. In this case, an example of the action range of the search action vec{aⱼ} is expressed as a following expression (24) when being expressed by a logical expression. Specifically, an element aₓ of the search action vec{aⱼ} is included in the action range from −10 to 10. aₓ is a₁, a₂, and a₃.

Āⱼ(\vec{α})≡̂ₓ₌₁³(−10≤αₓ≤10) (24)

In this case, the function ψⱼ for extending the search action vec{aⱼ} to the M dimension and converting the search action vec{aⱼ} into vec{a′ⱼ} is expressed as the following expression (25) when being expressed by a logical expression.

ψ̅ⱼ(\vec{α}, \vec{α}′)≡(̂ₓ₌₁⁸α′ₓ=α₁)̂(̂ₓ₌₉¹³α′ₓα₂)̂(̂ₓ₌₁₄²⁰α′ₓ=α₃) (25)

Specifically, the above-described expression (24) and the above-described expression (25) mean that the twenty air conditioning equipment is randomly classified into three groups and the search action vec{aⱼ} is determined for the three group. According to this, the information processing apparatus 100 is capable of reducing the number of elements a to be determined by the j-th reinforcement learner RL as the search action vec{aⱼ}, and is capable of suppressing an increase in the number of times of learning in the j-th reinforcement learning. Therefore, the information processing apparatus 100 is capable of reducing the processing amount required for the j-th reinforcement learning.

FIG. 9 is an explanatory diagram illustrating details of the j-th reinforcement learning in a case where mⱼ<M and there is an action constraint. In this case, when taking the element a₁ as an example for the sake of simplification of description, an example of the action constraint is expressed by the following equation (26). a₁⁺ indicates the upper limit of the element a₁. a₁⁻ indicates the lower limit of the element a₁.

A=(α₁⁻≤α₁≤α₁⁺) (26)

Therefore, the function ξⱼ for correcting the element a₁ is expressed by the following equation (27). The function ξⱼ for correcting the element a₁ is expressed by the following equation (28) when being expressed by a logical expression.

$$\begin{matrix}ξ ( {a}_{1} ) = \{ \begin{matrix}{a}_{1}^{-} & ( {a}_{1} < {a}_{1}^{-} ) \\ {a}_{1} & ( {a}_{1}^{-} < {a}_{1} < {a}_{1}^{+} ) \\ {a}_{1}^{+} & ( {a}_{1} > {a}_{1}^{+} )\end{matrix} & ( 27 ) \\ \overline{ξ} ( {a}_{1} , {a}_{1}^{′} ) = ( {a}_{1}^{′} = {a}_{1}^{-} {a}_{1} < {a}_{1}^{-} ) \\ ( {a}_{1}^{′} = {a}_{1} {a}_{1}^{-} < {a}_{1} < {a}_{1}^{+} ) \\ ( {a}_{1}^{′} = {a}_{1}^{+} {a}_{1} > {a}_{1}^{+} ) & ( 28 )\end{matrix}$$

Specifically, the above-described equation (27) and the above-described equation (28) mean that the element a′₁ is set to a⁺ when the element a₁ exceeds a⁺. A case where the element a₁ falls below a⁻ means that the element a′₁ is set to a⁻.

As illustrated in FIG. 9, in the j-th reinforcement learning, Cⱼ(vec(s_{T})) indicated by the following equation (29) may be set as the action vec{α} on the environment 110. It is possible to express the following equation (29) as the following equation (30).

Cⱼ(\vec{s})=ξⱼ(ξⱼ₋₁( . . . (ξ₂(ξ₁(C₀(s̅)+ψ₁(argmax_{\vec{α}∈A}_{₁}Q₁(\vec{s}, \vec{α})))+ψ₂(argmax_{\vec{α}∈A}_{₂}Q₂(\vec{s}, \vec{α})))+ . . . ++ψⱼ(argmax_{\vec{α}∈A}_{ⱼ}Qⱼ(\vec{s}, \vec{α}))) (29)

Cⱼ(\vec{s})=ξⱼ(Cⱼ₋₁(\vec{s})+ψⱼ(argmax α̅∈AⱼQⱼ(s̅, α̅))) (30)

The greedy action vec{a₀} is obtained by the basic controller C₀ based on the state vec{s_{T}} of the environment 110. The action vec{a′ᵢ} with j>i≥1 is obtained by correcting the greedy action vec{aᵢ} with ψᵢ. The greedy action vec{aᵢ} with j>i≥1 is obtained by the i-th reinforcement learner RLᵢ based on the state vec{s_{T}} of the environment 110. The action vec{a′ⱼ} is obtained by correcting the search action vec{aⱼ} by ψⱼ. The search action vec{aⱼ} is obtained by the j-th reinforcement learner RLⱼ. The action vec{b″₁} is ξ₁(vec{a₀}+vec{a′₁}). vec{b″ᵢ} is ξᵢ(vec{b″ᵢ₋₁}+vec{a′ᵢ}) in a case where i≥2.

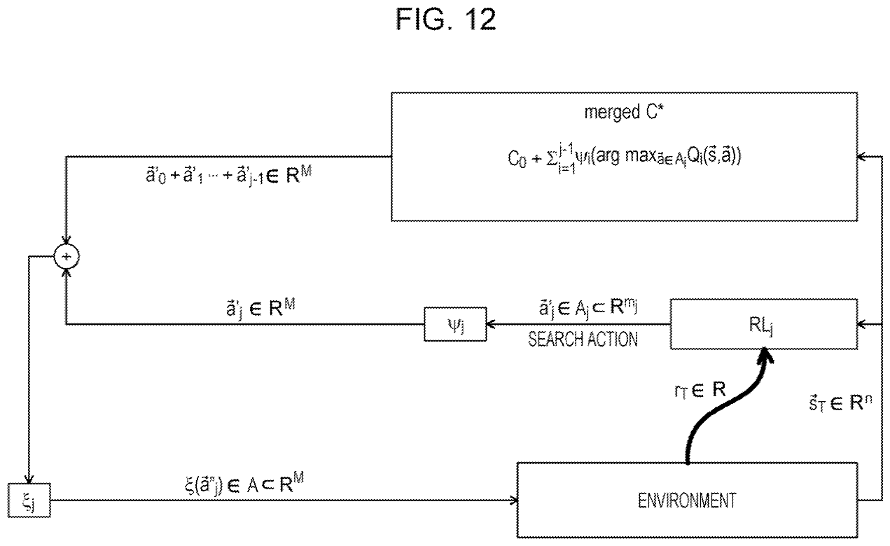

Here, as described above, when the merging is not performed, in the j-th reinforcement learning, the greedy action vec{aᵢ} of j−1≥i≥0 is calculated one by one, and an increase in processing amount is caused. Therefore, the information processing apparatus 100 preferably merges the basic controller C₀ and the reinforcement learners from the first reinforcement learner RL₁ to the (j−1)th reinforcement learner RLⱼ₋₁ with each other. A specific example of merging including the basic controller C₀ will be described later with reference to FIG. 12.

Here, a case where the information processing apparatus 100 further corrects the greedy action vec{a₀} according to the constraints by ξ₁ to ξⱼ each time the correction is performed by using the action vec{a′ᵢ} with j>i≥1, has been described, but the embodiment is not limited thereto. For example, a case where the information processing apparatus 100 collectively correct k after correcting the greedy action vec{a₀} by using the action vec{a′ᵢ} with j>i≥1, may be employed. This case will be described with reference to FIG. 10.

FIG. 10 is an explanatory diagram illustrating details of the j-th reinforcement learning in a case where the actions are collectively corrected. As illustrated in FIG. 10, in the j-th reinforcement learning, CAvec{sᵢ}) indicated by the following equation (19) may be set as the action vec{a} on the environment 110.

The greedy action vec{a₀} is obtained by the basic controller C₀ based on the state vec{s_{T}} of the environment 110. The action vec{a′ᵢ} with j>i≥1 is obtained by correcting the greedy action vec{aᵢ} with ψᵢ. The greedy action vec{aᵢ} with j>i≥1 is obtained by the i-th reinforcement learner RLᵢ based on the state vec{s_{T}} of the environment 110. The action vec{a′ⱼ} is obtained by correcting the search action vec{aⱼ} by ψⱼ. The search action vec{aⱼ} is obtained by the j-th reinforcement learner RLⱼ. The action vec{a″i} is vec{a′₀}+. . . +vec{a′ᵢ}.

Here, as described above, when the merging is not performed, in the j-th reinforcement learning, the greedy action vec{aᵢ} of j−1≥i≥1 is calculated one by one, and an increase in the processing amount is caused. Therefore, the information processing apparatus 100 preferably merges the reinforcement learners from the first reinforcement learner RL₁ to the (j−1)th reinforcement learner RLⱼ₋₁. A specific example of merging will be described later with reference to FIG. 11. Here, the description will be continued with reference to FIG. 11.

FIG. 11 is an explanatory diagram illustrating a specific example of the merging. In the example of FIG. 11, specifically, the merging described in FIG. 10 is described as a representative example among the merging described in FIG. 7, the merging described in FIG. 8, and the merging described in FIG. 10.

In FIG. 10, the j-th controller Cⱼ(vec{s_{T}}) is expressed by the above-described equation (19). Here, it is possible to describe subexpressions included in the above-described equation (19) and illustrated in the following expressions (31) to (33) by first-order predicate logical expressions.

$$\begin{matrix}{argmax}_{\vec{a} ∈ {A}_{j}} {Q}_{j} ( \vec{s} , \vec{a} ) & ( 31 ) \\ {ψ}_{j} ( {argmax}_{\vec{a}} {Q}_{j} ( \vec{s} , \vec{a} ) ) & ( 32 ) \\ {\sum }_{j} {ψ}_{j} ( {argmax}_{\vec{a}} {Q}_{j} ( \vec{s} , \vec{a} ) ) & ( 33 )\end{matrix}$$

Specifically, the above-described expressions (31) to (33) are expressed by the following expressions (34) to (36) when being expressed by the first-order predicate logical expressions.

P̅ⱼ(\vec{s}, \vec{α})≡Āⱼ(\vec{α})̂∀b̅(Āⱼ(\vec{b})→Qⱼ(\vec{s}, \vec{α})≥Qⱼ(\vec{s}, \vec{b})) (34)

P̅′ⱼ(\vec{s}, \vec{α}′)≡∃\vec{α}(ψ̅ⱼ(\vec{α}, \vec{α}′)̂P̅ⱼ(\vec{s}, \vec{α})) (35)

P̅″(\vec{s}, \vec{α}″)≡∃\vec{α}′₁ . . . ∃\vec{α}′ⱼ((P̅′₁(\vec{s}, \vec{α}′₁)̂ . . . ̂P̅′ⱼ(\vec{s}, \vec{α}′ⱼ)))̂\vec{α}″=\vec{α}′₁+ . . . +\vec{α}′ⱼ) (36)

Here, ∃vec{a} represents ∃a₁, . . . , and ∃aₘ. When vec{a′ⱼ}=a′ⱼ₁, . . . , and a′ⱼₘ, vec{a″ᵢ}=vec{a′₀}+ . . . +vec{a′₁}=a′₁₁+ . . . +a′ⱼ₁̂ . . . ̂a′_{1M}+ . . . +a′_{jM}.

In this manner, since the above-described expressions (34) to (36) are expressed by the first-order predicate logical expressions, it is possible to apply the quantifier elimination. Therefore, the information processing apparatus 100 applies the quantifier elimination, and in the j-th reinforcement learning, it is possible to generate the reinforcement learner RL*ⱼ in which the reinforcement learners from the first reinforcement learner RL₁ to the j-th reinforcement learner RLⱼ are merged with each other, as a logical expression.

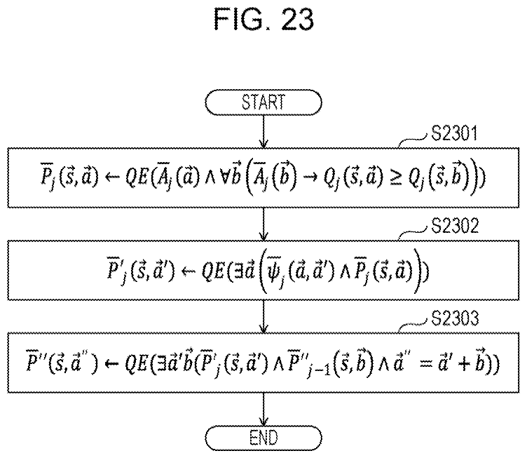

As illustrated in FIG. 11, in the j-th reinforcement learning, the information processing apparatus 100 is capable of using the reinforcement learner RL*ⱼ₋₁ in which the reinforcement learners from the first reinforcement learner RL₁ to the (j−1)th reinforcement learner RL*ⱼ₋₁ are merged with each other. The information processing apparatus 100 may calculate, for example, the basic controller C₀, the reinforcement learner RL*ⱼ₋₁, and the reinforcement learner RLⱼ, and may not calculate the reinforcement learners from the first reinforcement learner RL₁ to the (j−1)th reinforcement learner RLⱼ₋₁ one by one, and thus, it is possible to reduce the processing amount. More specifically, the information processing apparatus 100 is capable of realizing the merging by performing the merge processing which will be described later in FIG. 23.

FIG. 12 is an explanatory diagram illustrating a specific example of the merging including the basic controller C₀. In the example of FIG. 12, the merging described in FIG. 9 will be specifically described. In FIG. 9, the j-th controller Cⱼ(vec{s_{T}}) is expressed by the above-described equation (30).

Here, specifically, the above-described expressions (31) to (33) are expressed by the first-order predicate logical expressions, and are expressed by the above-described expressions (34) to (36). In the previous (j−1)th reinforcement learning, the (j−1)th controller Cⱼ₋₁ is expressed as a logical expression [Cⱼ₋₁(vec{s}, vec{a})].

Therefore, the information processing apparatus 100 applies the quantifier elimination to the following expression (37), and is capable of generating the new j-th controller Cⱼ in which the j-th reinforcement learner RLⱼ is merged with the (j−1)th controller Cⱼ₋₁ in the j-th reinforcement learning, as a logical expression.

Ĉⱼ(s,A)≡∃α″ξ(α″,A)̂∃s∃b∃α′(C̅_{J-1}(s, b) ̂P̅′ⱼ(s, α′) ̂α″=b+α′) (37)

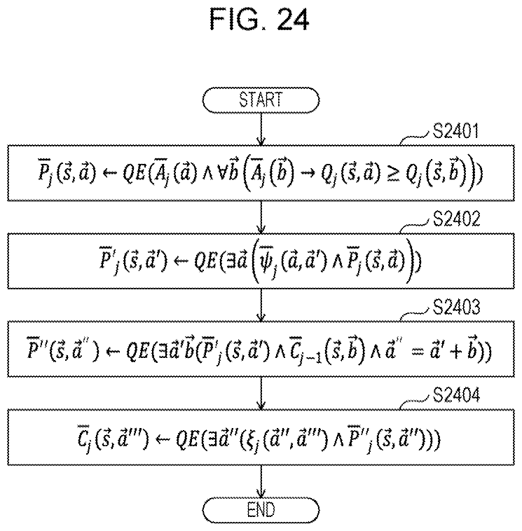

The information processing apparatus 100 is capable of using the logical expression [Cⱼ₋₁(vec{s}, vec{a})] that represents the (j−1)th controller Cⱼ₋₁ in the j-th reinforcement learning. The information processing apparatus 100 may calculate, for example, the (j−1)th controller Cⱼ₋₁ and the reinforcement learner RLⱼ, and may not calculate the basic controller C₀ and the reinforcement learners from the first reinforcement learner RL₁ to the (j−1)th reinforcement learner RLⱼ₋₁, and thus, it is possible to reduce the processing amount. Specifically, the information processing apparatus 100 is capable of realizing the merging by performing the merge processing which will be described later in FIG. 24.

(Effects Obtained by Information Processing Apparatus 100)

Next, effects obtained by the information processing apparatus 100 will be described with reference to FIGS. 13 to 16. First, a specific control example of the environment 110 by the information processing apparatus 100 will be described with reference to FIG. 13.

FIG. 13 is an explanatory diagram illustrating a specific control example of the environment 110. In the example of FIG. 13, the environment 110 is the room temperature of three rooms where air conditioners exist in each room. An object is to minimize the sum of squares of the error between the current room temperature of each room and the target temperature.

The basic controller C₀ is a PI controller. The sampling time is 1 minute and 1440 steps per day. The learning repetition number (number of episodes) is 1500, and a new reinforcement learner RLⱼ is added every 300 episodes. j≥1 is satisfied. The reinforcement learner RLⱼ outputs any one of the three actions of −0.025, 0, and 0.025 as each element of the search action vec{aⱼ} to be perturbed.

As illustrated in a graph 1300 in FIG. 13, the information processing apparatus 100 repeats the reinforcement learning based on the outside air temperature data for one day. For example, in the first reinforcement learning, the information processing apparatus 100 changes each element of the greedy action vec{a₀} obtained by the basic controller C₀ within an action range 1301 of −0.025 to 0.025, learns the reinforcement learner RL₁, and generates the first controller C₁.

For example, in the second reinforcement learning, the information processing apparatus 100 changes each element of the greedy action vec{a₁} obtained by the first controller C₁ within an action range 1302 of −0.025 to 0.025, learns the reinforcement learner RL₂, and generates the second controller C₂. Accordingly, the information processing apparatus 100 is capable of trying an action that is at most −0.05 to 0.05 away from the initial greedy action vec{a₀} obtained by the basic controller C₀.

In the third reinforcement learning, the information processing apparatus 100 changes each element of the greedy action vec{a₂} obtained by the second controller C₂ within an action range 1303 of −0.025 to 0.025, learns the reinforcement learner RL₃, and generates the third controller C₃. Accordingly, the information processing apparatus 100 is capable of trying an action that is at most −0.075 to 0.075 away from the initial greedy action vec{a₀} obtained by the basic controller C₀.

Similarly, the information processing apparatus 100 performs the fourth and subsequent reinforcement learning. In the j-th reinforcement learning, the information processing apparatus 100 changes each element of the greedy action vec{aⱼ₋₁} obtained by the (j−1)th controller Cⱼ₋₁ within an action range 1304 of −0.025 to 0.025, learns the reinforcement learner RLⱼ, and generates the j-th controller Cⱼ. In this manner, the information processing apparatus 100 is capable of trying the action largely away from the initial greedy action vec{a₀} obtained by the basic controller C₀ by repeating the reinforcement learning RLⱼ even when the action range Aⱼ to be searched for each reinforcement learning RLⱼ.

Therefore, even when the action range Aⱼ to be searched for each reinforcement learning RLⱼ is relatively narrow, the information processing apparatus 100 is capable of finally determining the greedy action that maximizes the value of the action and is capable of generating the j-th controller q that is capable of appropriately controlling the environment 110. Further, since the action range Aⱼ searched for each reinforcement learning RLⱼ is relatively narrow, the information processing apparatus 100 is capable of reducing the number of action trials for each reinforcement learning RLⱼ and reducing the processing amount.

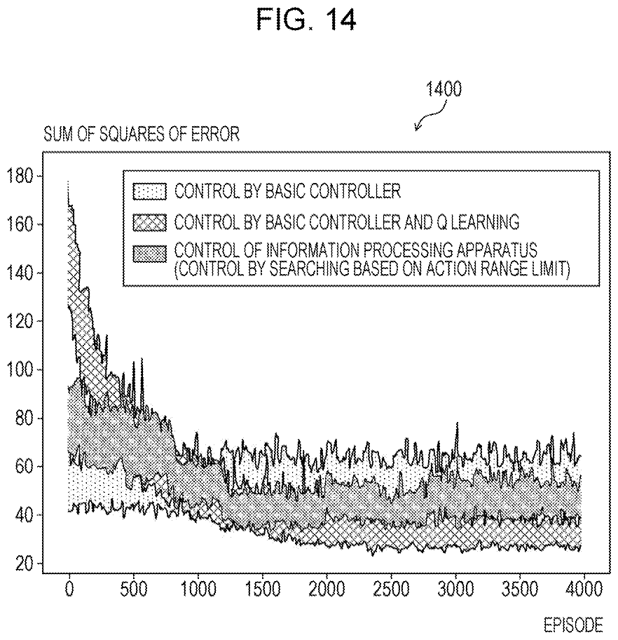

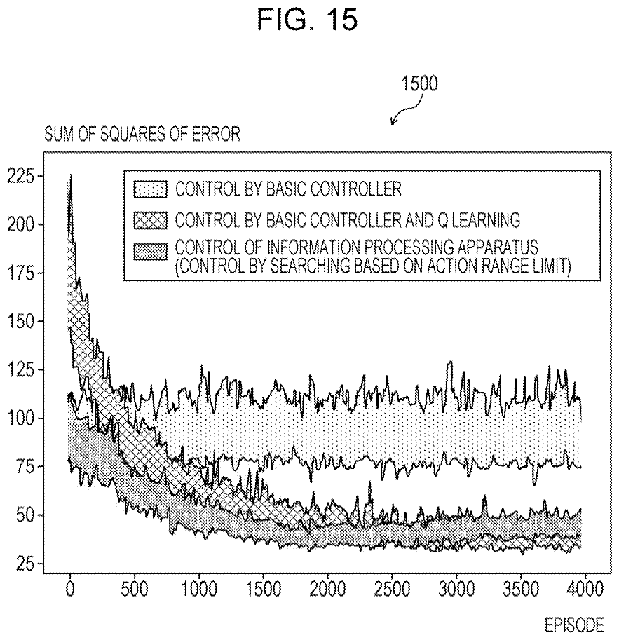

Next, the result that the information processing apparatus 100 repeats the reinforcement learning in the control example of FIG. 13 will be described with reference to FIGS. 14 and 15.

FIGS. 14 and 15 are explanatory diagrams illustrating the result of repeating the reinforcement learning. A graph 1400 in FIG. 14 represents the change of the sum of squares of the errors between the room temperature and the set temperature in a case where the environment 110 is controlled by the basic controller, in a case where the environment 110 is controlled by the basic controller and the Q learning, and in a case where the information processing apparatus 100 controls the environment 110 by searching based on the action range limit, In FIG. 14, 1 episode=400 steps is satisfied.

As illustrated in FIG. 14, in a case where the environment 110 is controlled by the basic controller, it is difficult to reduce the square error. Meanwhile, in a case where the environment 110 is controlled by the basic controller and the Q learning, there is a case where the square error becomes large in the first half of the learning, and there is a case the environment 110 is adversely affected. In contrast, the information processing apparatus 100 is capable of reducing the square error while avoiding the action that adversely affects the environment 110 in which the square error becomes large.

A graph 1500 in FIG. 15 represents the change of the sum of squares of the errors between the room temperature and the set temperature in a case where the environment 110 is controlled by the basic controller, in a case where the environment 110 is controlled by the basic controller and the Q learning, and in a case where the information processing apparatus 100 controls the environment 110 by searching based on the action range limit. In FIG. 15, 1 episode=500 steps is satisfied.

As illustrated in FIG. 15, in a case where the environment 110 is controlled by the basic controller, it is difficult to reduce the square error. Meanwhile, in a case where the environment 110 is controlled by the basic controller and the Q learning, there is a case where the square error becomes large, and there is a case the environment 110 is adversely affected. In contrast, the information processing apparatus 100 is capable of reducing the square error while avoiding the action that adversely affects the environment 110 in which the square error becomes large.

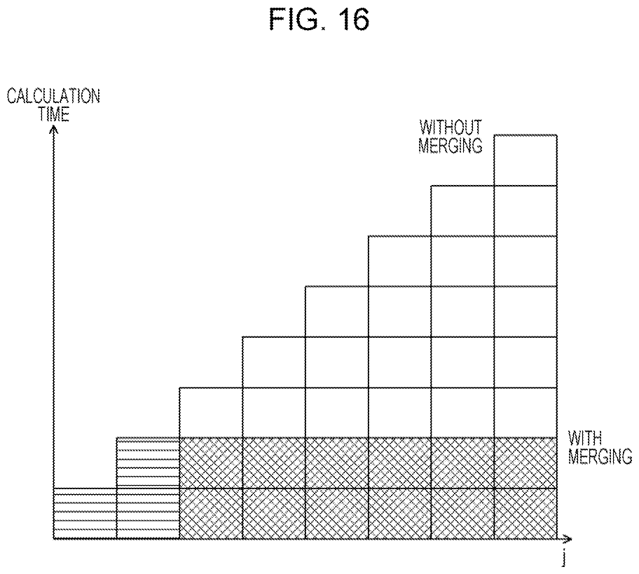

Next, a change in the processing amount for each reinforcement learning will be described with reference to FIG. 16,

FIG. 16 is an explanatory diagram illustrating a change in the processing amount for each reinforcement learning. As illustrated in FIG. 16 in a case where the reinforcement learners are not merged, the number of reinforcement learners included in the latest controller increases as the reinforcement learning is repeated. Therefore, as the reinforcement learning is repeated, the processing amount or calculation time required when determining the greedy action by the latest controller increases in proportion to the number of reinforcement learners.

In contrast, the information processing apparatus 100 is capable of merging the reinforcement learners. Therefore, even when the reinforcement learning is repeated, the information processing apparatus 100 is capable of setting the number of reinforcement learning included in the latest controller to be below a certain level. As a result, even when the reinforcement learning is repeated, the processing amount or calculation time required when determining the greedy action by the latest controller is suppressed to be below a certain level.

(Specific Example of Environment 110)

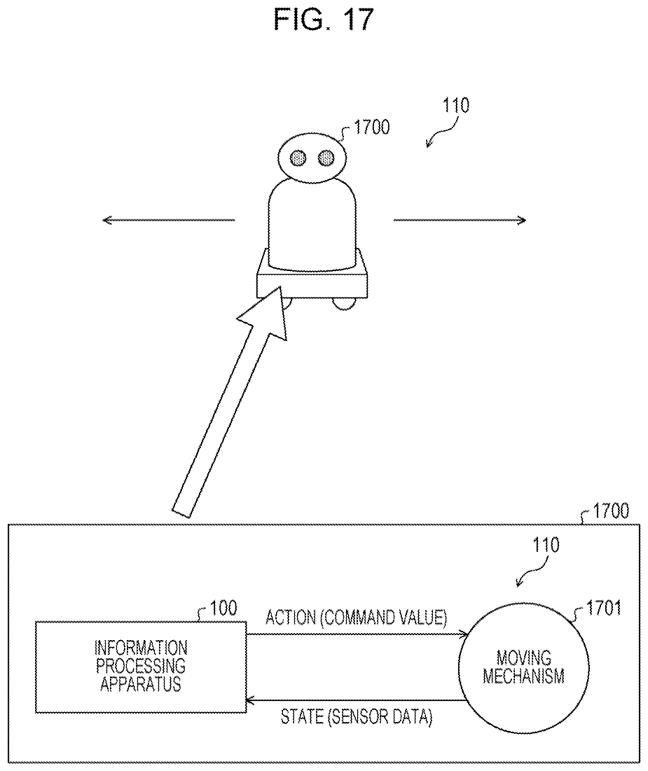

Next, a specific example of the environment 110 will be described with reference to FIGS. 17 to 19,

FIGS. 17 to 19 are explanatory diagrams illustrating specific examples of the environment 110. In the example of FIG. 17, the environment 110 is an autonomous moving object 1700, specifically, a moving mechanism 1701 of the autonomous moving object 1700. The autonomous moving object 1700 is specifically a drone, a helicopter, an autonomous mobile robot, an automobile, or the like. The action is a command value for the moving mechanism 1701, The action is, for example, a command value related to a moving direction, a moving distance, or the like.

For example, when the autonomous moving object 1700 is a helicopter, the action includes the speed of a rotating blade, the gradient of a rotating surface of the rotating blade, and the like. For example, when the autonomous moving object 1700 is an automobile, the action includes the strength of an accelerator or a brake, the direction of the steering wheel, and the like. The state is sensor data from a sensor device provided in the autonomous moving object 1700, such as the position of the autonomous moving object 1700. The reward is a value obtained by multiplying the cost by a negative value. The cost is, for example, an error between the target operation of the autonomous moving object 1700 and the actual operation of the autonomous moving object 1700.

Here, the information processing apparatus 100 is capable of stopping the command value that causes an increase in the error between the target operation of the autonomous moving object 1700 and the actual operation of the autonomous moving object 1700 from being determined as the command value that becomes the search action. Therefore, the information processing apparatus 100 is capable of stopping an inappropriate action that adversely affects the autonomous moving object 1700.

For example, when the autonomous moving object 1700 is a helicopter, the information processing apparatus 100 is capable of stopping the helicopter from being damaged by being out of balance and falling. For example, when the autonomous moving object 1700 is an autonomous mobile robot, the information processing apparatus 100 is capable of stopping the autonomous mobile robot from being damaged by falling out of balance or colliding with an obstacle.

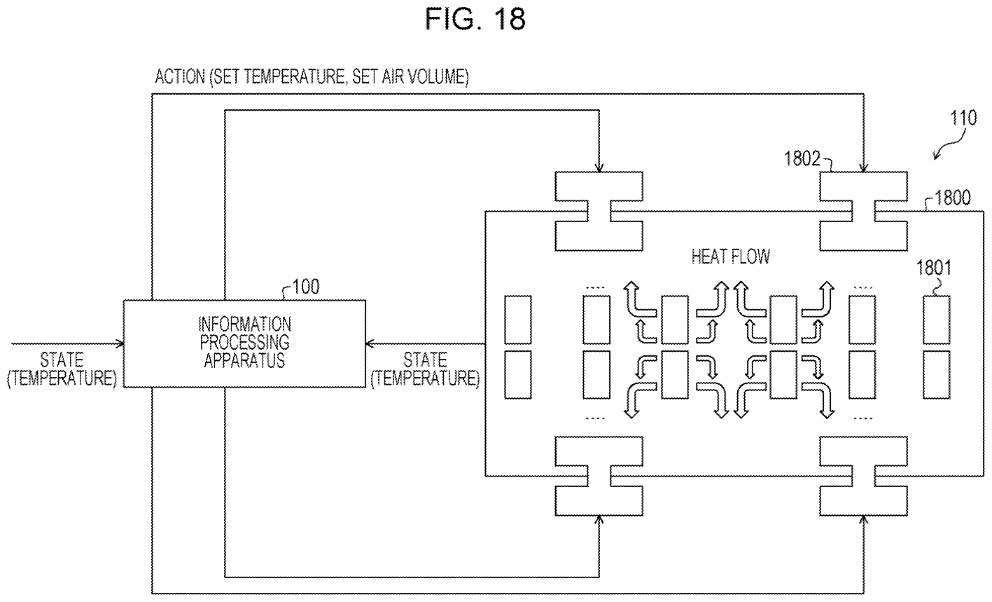

In the example of FIG. 18, the environment 110 is a server room 1800 including a server 1801 that is a heat source and a cooler 1802, such as CRAC or Chiller. The action is a set temperature or a set air volume for the cooler 1802. The state is sensor data from a sensor device provided in the server room 1800, such as the temperature. The state may be data related to the environment 110 obtained from a target other than the environment 110, and may be, for example, temperature or weather. The reward is a value obtained by multiplying the cost by a negative value. The cost is, for example, the sum of squares of the error between the target room temperature and the current room temperature.

Here, the information processing apparatus 100 is capable of stopping the action that makes the temperature of the server room 1800 a high temperature that causes a server in the server room 1800 to break down or malfunction from being determined as the search action. The information processing apparatus 100 is capable of stopping the action that largely increases the power consumption for 24 hours in the server room 1800 from being determined as the search action. Therefore, the information processing apparatus 100 is capable of stopping an inappropriate action that adversely affects the server room 1800.

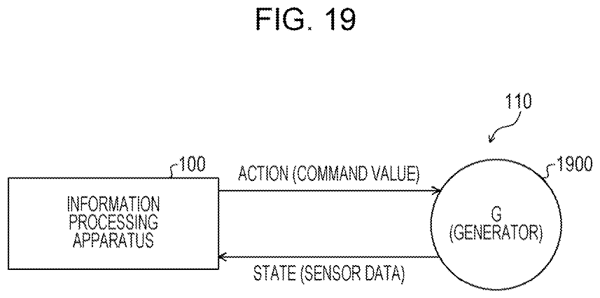

In the example of FIG. 19, the environment 110 is a generator 1900. The action is a command value for the generator 1900. The state is sensor data from a sensor device provided in the generator 1900, and is, for example, a power generation amount of the generator 1900, a rotation amount of a turbine of the generator 1900, or the like. The reward is, for example, a power generation amount for 5 minutes of the generator 1900,

Here, the information processing apparatus 100 is capable of stopping the command value that causes a high speed rotation of a turbine of the generator 1900 that causes the turbine of the generator 1900 to be likely to break down from being determined as the command value that becomes the search action. The information processing apparatus 100 is capable of stopping a command value that reduces the power generation amount for 24 hours of the generator 1900 from being determined as the command value that causes the search action. Therefore, the information processing apparatus 100 is capable of stopping an inappropriate action that adversely affects the generator 1900.

The environment 110 may be a simulator of the above-described specific example. The environment 110 may be a robot arm that manufactures a product. The environment 110 may be, for example, a chemical plant. The environment 110 may be, for example, a game. The game is, for example, a type of game in which the action is an order scale and the action is not a nominal scale.

(Reinforcement Learning Processing Procedure)

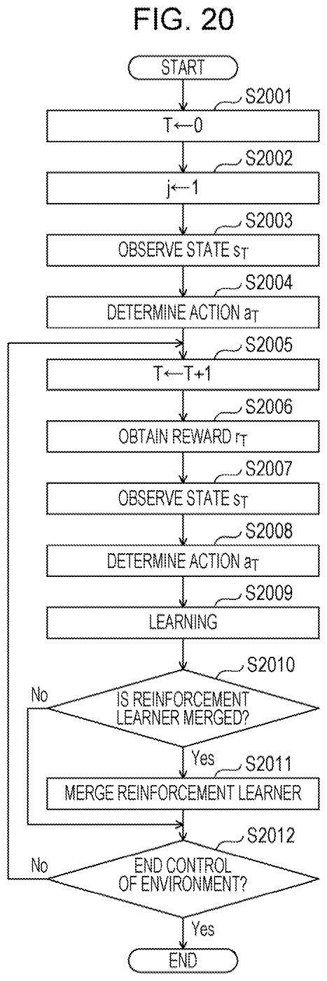

Next, an example of the reinforcement learning processing procedure to be performed by the information processing apparatus 100 will be described with reference to FIG. 20. The reinforcement learning processing is realized by, for example, the CPU 201, the storage region, such as the memory 202 or the recording medium 205, and the network I/F 203 which are illustrated in FIG. 2.

FIG. 20 is a flowchart illustrating an example of the reinforcement learning processing procedure. In FIG. 20, the information processing apparatus 100 sets the variable T (Le., the time point) to be 0 (step S2001). The information processing apparatus 100 sets the variable j (i.e., the number of he performed reinforcement learning) to be 1 (step S2002).

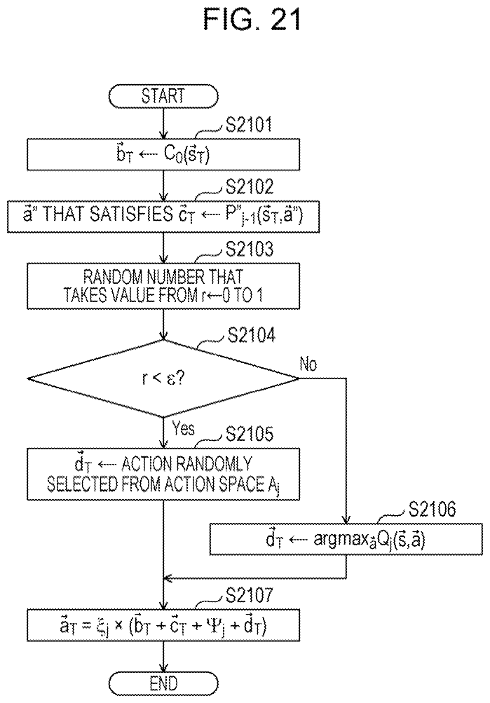

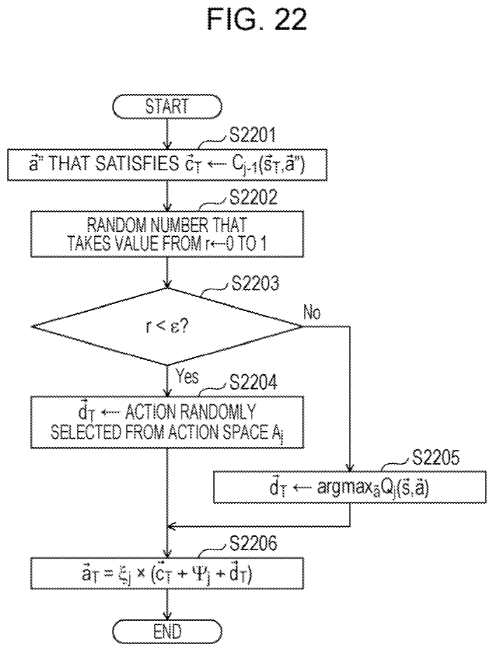

Next, the information processing apparatus 100 observes the state vec{s_{T}} and stores the observed state vec{s_{T}} by using the history table 300 (step S2003). Then, the information processing apparatus 100 determines the action vec{α_{T}} by performing action determining processing which will be described later in FIG. 21 or action determining processing which will be described later in FIG. 22 based on the state vec{s_{T}}, and stores the determined action vec{α_{T}} by using the history table 300 (step S2004).

Next, the information processing apparatus 100 waits for the unit time to elapse and sets T to T+1 (step S2005). Then, the information processing apparatus 100 acquires the reward r_{T} that corresponds to the action vec{α_{T-1}}, and stores the acquired reward r_{T} by using the history table 300 (step S2006).

Next, the information processing apparatus 100 observes the state vec{s_{T}} and stores the observed state vec{s_{T}} by using the history table 300 (step S2007). Then, the information processing apparatus 100 determines the action vec{α_{T}} by performing action determining processing which will be described later in FIG. 21 or action determining processing which will be described later in FIG. 22 based on the state vec{s_{T}}, and stores the determined action vec{α_{T}} by using the history table 300 (step S2008).

Next, the information processing apparatus 100 refers to the history table 300 and learns the action value function using the j-th reinforcement learner based on the state vec{_{T-1}}, the action vec{α_{T-1}}, the reward vec{r_{T}}, the state vec{s_{T}}, and the action vec{α_{T}} (step S2009).

Then, the information processing apparatus 100 determines whether to merge reinforcement learners (step S2010). Here, in a case where it is determined to merge (step S2010: Yes), the information processing apparatus 100 proceeds to the process of step S2011. Meanwhile, in a case it is determined not to merge (step S2010: No), the information processing apparatus 100 proceeds to the process of step S2012.

In step S2011, the information processing apparatus 100 merges the reinforcement learners by performing merge processing which will be described later in FIG. 23 or merge processing which will be described later in FIG. 24 (step S2011). Then, the information processing apparatus 100 increments j and proceeds to the process of step S2012.

In step S2012, the information processing apparatus 100 determines whether to end the control of the environment 110 (step S2012). Here, in a case where the control of the environment 110 is continued (step S2012: No), the information processing apparatus 100 returns to the process of step S2005,

Meanwhile, in a case where the control of the environment 110 ends (step S2012: Yes), the information processing apparatus 100 ends the reinforcement learning processing. Accordingly, the information processing apparatus 100 is capable of repeating the process of generating the new controller that is capable of determining the greedy action that is determined to be more appropriate than the greedy action obtained by the current controller while avoiding an inappropriate action.

In the example of FIG. 20, a case where the information processing apparatus 100 performs the reinforcement learning processing in a batch processing format has been described, but the embodiment is not limited thereto. For example, there may be a case where the information processing apparatus 100 performs the reinforcement learning processing in a sequential processing format.

(Action Determining Processing Procedure)

Next, an example of the action determining processing procedure to be performed by the information processing apparatus 100 will be described with reference to FIG. 21. The action determining processing is realized by, for example, the CPU 201, the storage region, such as the memory 202 or the recording medium 205, and the network I/F 203 which are illustrated in FIG. 2.

FIG. 21 is a flowchart illustrating an example of the action determining processing procedure. In FIG. 21, the information processing apparatus 100 substitutes the state vec{s_{T}} to the basic controller C₀ and determines the greedy action vec{b_{T}} (step S2101). Next, the information processing apparatus 100 determines the greedy action vec{c_{T}} by the following expression (38) (step S2102).

\vec{α}″ satisfies \vec{c}_{T}←P″ⱼ₋₁(\vec{s}_{T}, \vec{α}″) (₃₈)

Then, the information processing apparatus 100 generates a random number that takes a value from 0 to 1, and sets the generated random number to the variable r (step S2103).

Next, the information processing apparatus 100 determines whether r<ε (step S2104). Here, in a case where r<ε (step S2104: Yes), the information processing apparatus 100 proceeds to the process of step S2105. Meanwhile, in a case r<ε is not satisfied (step S2104: No), the information processing apparatus 100 proceeds to the process of step S2106.

In step S2105, the information processing apparatus 100 randomly determines the search action vec{d_{T}} from the action space Aⱼ (step S2105). Then, the information processing apparatus 100 proceeds to the process of step S2107.

In step S2106, the information processing apparatus 100 determines the search action vec{d_{T}} by the following equation (39) (step S2106).

\vec{d}_{T}=argmax_{\hat{α}}Q_{f}(\vec{s}, \vec{α}) (39)

Then, the information processing apparatus 1.00 proceeds to the process of step S2107.

In step S2107, the information processing apparatus 100 determines the action vec{α_{T}}=ξⱼ(greedy action vec{b_{T}}+greedy action vec{c_{T}}+ψⱼ (search action vec{d_{T}})) (step S2107). Then, the information processing apparatus 100 ends the action determining processing. Accordingly, the information processing apparatus 100 is capable of determining the action on the environment 110.

(Action Determining Processing Procedure)

Next, another example of the action determining processing procedure to be performed by the information processing apparatus 100 will be described with reference to FIG. 22. The action determining processing is realized by, for example, the CPU 201, the storage region, such as the memory 202 or the recording medium 205, and the network I/F 203 which are illustrated in FIG. 2.

FIG. 22 is a flowchart illustrating another example of the action determining processing procedure. In FIG. 22, the information processing apparatus 100 determines the greedy action vec{c_{T}} by the following expression (40) (step S2201).

\vec{α}″ satisfies ĉ_{T}←Cⱼ₋₁(\vec{s}_{T}, \vec{α}″) (40)

Then, the information processing apparatus 100 generates a random number that takes a value from 0 to 1, and sets the generated random number to the variable r (step S2202).

Next, the information processing apparatus 100 determines whether r<ε (step S2203). Here, in a case where r<ε (step S2203: Yes), the information processing apparatus 100 proceeds to the process of step S2204. Meanwhile, in a case r<ε is not satisfied (step S2203: No), the information processing apparatus 100 proceeds to the process of step S2205.

In step S2204, the information processing apparatus 100 randomly determines the search action vec{d_{T}} from the action space Aⱼ (step S2204), Then, the information processing apparatus 100 proceeds to the process of step S2206.

In step S2205, the information processing apparatus 100 determines the search action vec{d_{T}} by the following equation (41) (step S2205).

\vec{d}_{T}=argmax_{α̅}Qⱼ(\vec{s}, \vec{α}) (41)

Then, the information processing apparatus 100 proceeds to the process of step S2206.

In step S2206, the information processing apparatus 100 determines the action vec{α_{T}}=ξⱼ(greedy action vec{c_{T}}+ψⱼ(search action vec{d_{T}})) (step S2206). Then, the information processing apparatus 100 ends the action determining processing. Accordingly, the information processing apparatus 100 is capable of determining the action on the environment 110.

(Merge Processing Procedure)

Next, an example of a merge processing procedure to be performed by the information processing apparatus 100 will be described with reference to FIG. 23. The merge processing is realized by, for example, the CPU 201, the storage region, such as the memory 202 or the recording medium 205, and the network I/F 203 which are illustrated in FIG. 2.

FIG. 23 is a flowchart illustrating an example of the merge processing procedure. In FIG. 23, the information processing apparatus 100 generates a logical expression [Pⱼ(vec{s}, vec{a})] from the above-described expression (12) (step S2301).

Next, the information processing apparatus 100 generates a logical expression [P′ⱼ(vec{s}, vec{a})] from the above-described expression (13) (step S2302). Next, the information processing apparatus 100 generates a logical expression [P″ⱼ(vec{s}, vec{a})] from the above-described expression (14) (step S2303). Accordingly, the information processing apparatus 100 is capable of expressing the result of merging the plurality of reinforcement learners as a logical expression [P″ⱼ(vec{s}, vec{a})].

(Merge Processing Procedure)

Next, another example of a merge processing procedure to be performed by the information processing apparatus 100 will be described with reference to FIG. 24. The merge processing is realized by, for example, the CPU 201, the storage region, such as the memory 202 or the recording medium 205, and the network I/F 203 which are illustrated in FIG. 2.

FIG. 24 is a flowchart illustrating another example of the merge processing procedure. In FIG. 24, the information processing apparatus 100 generates a logical expression [Pⱼ(vec{s}, vec{a})] from the above-described expression (15) (step S2401).

Next, the information processing apparatus 100 generates a logical expression [P′ⱼ(vec{s}, vec{a})] from the above-described expression (16) (step S2402). Next, the information processing apparatus 100 generates a logical expression [P″ⱼ(vec{s}, vec{a})] from the above-described expression (17) (step S2403).

Thereafter, the information processing apparatus 100 generates a logical expression [Cⱼ(vec{s}, vec{a})] from the above-described expression (18) (step S2404). Accordingly, the information processing apparatus 100 is capable of expressing the result of merging the basic controller and the plurality of reinforcement learners as a logical expression [Cⱼ(vec{s}, vec{a})].

Here, the information processing apparatus 100 may change the order of process in some steps in each flowchart illustrated in FIGS. 20 to 24. The information processing apparatus 100 may omit process in some steps in each flowchart in FIGS. 20 to 24,

As described above, according to the information processing apparatus 100, it is possible to perform the first reinforcement learning in the action range smaller than the action range limit based on the action obtained by the basic controller. According to the information processing apparatus 100, it is possible to perform the second reinforcement learning in the action range smaller than the action range limit based on the action obtained by the first controller that includes the first reinforcement learner learned by the first reinforcement learning. According to the information processing apparatus 100, it is possible to perform the third reinforcement learning in the action range smaller than the action range limit based on the action obtained by the second controller that includes the reinforcement learner obtained by merging the first reinforcement learner and the second reinforcement learner learned by the second reinforcement learning. Accordingly, the information processing apparatus 100 is capable of stopping the action that is more than a certain distance away from the greedy action determined to be optimum by the latest controller and avoiding an inappropriate action that adversely affects the environment 110. In addition, the information processing apparatus 100 is capable of reducing the number of reinforcement learners included in the second controller generated by the second reinforcement learning, and suppressing the increase in processing amount.

According to the information processing apparatus 100, in the third reinforcement learning, it is possible to generate the third controller that includes the reinforcement learner obtained by merging the reinforcement learner merged immediately before and the third reinforcement learner learned by the third reinforcement learning. According to the information processing apparatus 100, it is possible to repeat the process of performing the third reinforcement learning in the action range smaller than the action range limit based on the action obtained by the third controller generated by the third reinforcement learning immediately before. Accordingly, even when the third reinforcement learning is repeated, the information processing apparatus 100 is capable of maintaining the number of reinforcement learners included in the latest controller below a certain level, and suppressing the increase in the processing amount.

According to the information processing apparatus 100, it is possible to generate the first controller by merging the basic controller and the first reinforcement learner learned by the first reinforcement learning with each other. According to the information processing apparatus 100, it is possible to generate the second controller by merging the reinforcement learner merged immediately before and the second reinforcement learner learned by the second reinforcement learning with each other. Accordingly, the information processing apparatus 100 is capable of setting the basic controller as a merging target.

According to the information processing apparatus 100, it is possible to realize the merging by using the quantifier elimination with respect o the logical expression using a polynomial. Accordingly, the information processing apparatus 100 is capable of realizing the merging of the reinforcement learners with each other in a case where the reinforcement learners use the state action value function expressed in a polynomial.

In addition, it is possible to realize the reinforcement learning method described according to the embodiment by causing a computer, such as a personal computer or a workstation, to execute a prepared program. The reinforcement learning program described in the embodiment is recorded on a computer-readable recording medium, such as a hard disk, a flexible disk, a CD-ROM, a MO, or a DVD, and is executed as a result of being read from the recording medium by a computer. In addition, the reinforcement learning program described in the embodiment may be distributed through a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A reinforcement learning method performed by a computer, the reinforcement learning method comprising:
performing, based on an action obtained by a basic controller that defines an action on a state of an environment, first reinforcement learning to obtain a first reinforcement learner by using a state action value function expressed in a polynomial in an action range smaller than an action range limit for the environment;
performing, based on an action obtained by a first controller that includes the first reinforcement learner, second reinforcement learning to obtain a second reinforcement learner by using a state action value function expressed in a polynomial in an action range smaller than the action range limit; and
performing, based on an action obtained by a second controller that includes a second merged reinforcement learner obtained by merging the first reinforcement learner and the second reinforcement learner, third reinforcement learning to obtain a third reinforcement leaner by using a state action value function expressed in a polynomial in an action range smaller than the action range limit.

2. The reinforcement learning method of claim 1, further comprising:
repeatedly performing a reinforcement learning process for integer j starting from 4 while incrementing j by 1, the reinforcement learning process including
performing, based on an action obtained by a j-th controller that includes a j-th merged reinforcement learner obtained by merging the (j−1)-th merged reinforcement learner obtained immediately before and a (j−1)-th reinforcement learner obtained by the (j−1)-th reinforcement learning performed immediately before, j-th reinforcement learning to obtain a j-th reinforcement learner by using a state action value function expressed in a polynomial in an action range smaller than the action range limit.

3. The reinforcement learning method of claim 1, wherein:
the second reinforcement learning is performed in an action range smaller than the action range limit, based on an action obtained by the first controller that includes a first merged reinforcement learner obtained by merging the basic controller and the first reinforcement learner; and
the third reinforcement learning is performed in an action range smaller than the action range limit, based on an action obtained by the second controller that includes a third merged reinforcement leaner obtained by merging the first merged reinforcement learner and the second reinforcement learner.

4. The reinforcement learning method of claim 1, wherein
the merging is performed by using a quantifier elimination with respect to a logical expression using a polynomial.

5. A non-transitory, computer-readable recording medium having stored therein a program for causing a computer to execute a process comprising:
performing, based on an action obtained by a basic controller that defines an action on a state of an environment, first reinforcement learning to obtain a first reinforcement learner by using a state action value function expressed in a polynomial in an action range smaller than an action range limit for the environment;
performing, based on an action obtained by a first controller that includes the first reinforcement learner, second reinforcement learning to obtain a second reinforcement learner by using a state action value function expressed in a polynomial in an action range smaller than the action range limit; and
performing, based on an action obtained by a second controller that includes a merged reinforcement learner obtained by merging the first reinforcement learner and the second reinforcement learner, third reinforcement learning to obtain a third reinforcement leaner by using a state action value function expressed in a polynomial in an action range smaller than the action range limit.

6. An apparatus comprising:
a memory; and
a processor coupled to the memory and configured to:
perform, based on an action obtained by a basic controller that defines an action on a state of an environment, first reinforcement learning to obtain a first reinforcement learner by using a state action value function expressed in a polynomial in an action range smaller than an action range limit for the environment,
perform, based on an action obtained by a first controller that includes the first reinforcement learner, second reinforcement learning to obtain a second reinforcement learner by using a state action value function expressed in a polynomial in an action range smaller than the action range limit, and
perform, based on an action obtained by a second controller that includes a merged reinforcement learner obtained by merging the first reinforcement learner and the second reinforcement learner, third reinforcement learning to obtain a third reinforcement leaner by using a state action value function expressed in a polynomial in an action range smaller than the action range limit.
